(19) United States
(12) Patent Application Publication
(10) Pub. No.: US 2020/0160732 A1
(43) Pub. Date: May 21, 2020

(54) AREA EVALUATION SYSTEM, METHOD, AND PROGRAM

(71) Applicant: NEC Corporation, Tokyo (JP)

(72) Inventors: Shinji NAKADAI, Tokyo (JP); Hiroaki INOTSUME, Tokyo (JP)

(73) Assignee: NEC Corporation, Tokyo (JP)

(21) Appl. No.: 16/626,766

(22) PCT Filed: Jun. 22, 2018
(86) PCT No.: PCT/JP2018/023815

§ 371 Date: Dec. 26, 2019

(30) Foreign Application Priority Data
Jun. 30, 2017 (JP) 2017-128392

(51) Int. Cl. G08G 5/00; B64C 39/02; G05D 1/10; G06Q 10/04

(52) U.S. Cl. CPC G08G 5/0069; G08G 5/0034; G06Q 10/047; B64C 39/024; G05D 1/106; G08G 5/0013

(57) ABSTRACT

An area evaluation system includes a utility evaluation means 501 that, in a case where a route selection area in which a route is selected is changed, evaluates a utility of at least a partial area included in a pre-change or post-change route selection area based on operation routes for an operation plan of a mobile object in pre-change and post-change areas.

### TECHNICAL FIELD

The present invention relates to an area evaluation system, an area evaluation method, and an area evaluation program for evaluating an area used for the operation of a mobile object.

### BACKGROUND ART

The use of unmanned aircraft systems (UAS) such as drones for air transportation and the like is under consideration. In order to utilize UAS, a mechanism to manage UAS operation plans and areas used therefor is necessary. Thus, various methods of such UAS operation management (UAS traffic management, UTM) have been studied.

As well as UAS, an operation management system that manages the operation of a mobile object requires a technique for avoiding conflict between mobile objects. One method for avoiding conflict between mobile objects is a centralized operation management system in which a single control system centrally manages the operation plans of all mobile objects and the areas used for the operations.

However, a centralized operation management system is problematic and not preferable because when a large number of requests for approval of operation plans are accumulated, it is difficult to approve quickly while considering consistency between operation plans, and all operations are suspended in the event of a failure.

Therefore, let us consider a distributed operation management system. Specifically, let us consider a distributed operation management system in which areas are assigned to a plurality of operation management systems, the authority to approve mobile operation plans in the assigned area is delegated to each operation management system, and each operation management system manages the operation of each mobile object within the assigned area.

By assigning an area exclusively to each operation management system, such a distributed operation management system enables each operation management system to independently approve operation plans while avoiding conflict between mobile objects of different operation management systems, so that the above-mentioned problems can be avoided.

However, it is important for a distributed operation management system how each operation management system can secure a high-utility area for the operation of a mobile object managed by itself. A technique for evaluating an area used for operation is described in PTL 1, for example.

### CITATION LIST

### Patent Literature

PTL 1: Japanese Patent Application Laid-Open No. 2017-033232

### SUMMARY OF INVENTION

### Technical Problem

In particular, it is desirable for a distributed operation management system that each operation management system have a high degree of independence so as to be flexible in its operation service. For this reason, the degree of independence of each operation management system is preferably increased by enabling each operation management system to independently apply for an area based on the operation plan of a mobile object managed by itself, or by enabling operation management systems to exchange their occupied areas.

In this case, in order for each operation management system to apply for an area with higher utility or to effectively negotiate an occupied area with another operation management system, the utility of an area used for operation should be appropriately evaluated in accordance with the operation plan managed by the operation management system.

The importance of such area evaluation is applied not only to distributed operation management systems but also, for example, to area negotiations between mobile objects that operate autonomously while securing occupancy rights on areas used for their operation plans.

In addition to area negotiations, in all situations where, for example, the area in which a route is selected (hereinafter referred to as a route selection area) is changed by an action such as application or permission by those that have the authority to manage the operation of a mobile object (including the mobile object itself), it is important to evaluate the utility of an area associated with the change.

Note that the method described in PTL 1 only changes the route selection area in accordance with the effect of wind speed or determines the optimal route in the latest route selection area using a cost function that includes the effect of wind speed as a constraint, and does not evaluate the utility of an area associated with the change of the route selection area as described above. For example, the method described in PTL 1 does not determine how much impact the utility (loss) of a nearby voxel that can no longer be used due to the effect of wind speed or the utility of a new area that is secured from another entity can have on a target operation plan.

Thus, an object of the present invention is to provide an area evaluation system, an area evaluation method, and an area evaluation program capable of appropriately evaluating the utility of an area used for operation in accordance with a designated operation plan.

### Solution to Problem

An area evaluation system according to the present invention includes a utility evaluation means that, in a case where a route selection area in which a route is selected is changed, evaluates a utility of at least a partial area included in a pre-change or post-change route selection area based on operation routes for an operation plan of a mobile object in pre-change and post-change areas.

An area evaluation method according to the present invention includes evaluating, by an information processing device, in a case where a route selection area in which a route is selected is changed, a utility of at least a partial area included in a pre-change or post-change route selection area based on operation routes for an operation plan of a mobile object in pre-change and post-change areas.

An area evaluation program according to the present invention causes a computer to execute a process of, in a case where a route selection area in which a route is selected is changed, evaluating a utility of at least a partial area included in a pre-change or post-change route selection area based on operation routes for an operation plan of a mobile object in pre-change and post-change areas.

### Advantageous Effects of Invention

According to the present invention, the utility of an area used for operation can be appropriately evaluated in accordance with a designated operation plan.

### BRIEF DESCRIPTION OF DRAWINGS

FIG. 1 It depicts a schematic configuration diagram of a mobile operation system 100 including an operation management system 20.

FIG. 2 It depicts an explanatory diagram illustrating classification of management target areas in an area management system 10.

FIG. 3 It depicts a block diagram illustrating a configuration example of an area evaluation means 30.

FIG. 4 It schematically depicts areas.

FIG. 5 It schematically depicts areas.

FIG. 6 It schematically depicts areas.

FIG. 7 It depicts a flowchart illustrating an example of the operation of the area evaluation means 30.

FIG. 8 It depicts a flowchart illustrating an example of the operation of the area evaluation means 30.

FIG. 9 It depicts a flowchart illustrating an example of the operation of the area evaluation means 30.

FIG. 10 It depicts an explanatory diagram illustrating an example of a node map and costs.

FIG. 11 It depicts an explanatory diagram illustrating a pseudocode of a simple A-star-based optimal route planning algorithm.

FIG. 12 It depicts an explanatory diagram illustrating pseudocodes of a primary route search process and a secondary route search process.

FIG. 13 It depicts an explanatory diagram illustrating an example of the identifiers and graph representation of areas in a map.

FIG. 14 It depicts an explanatory diagram illustrating an example of a map.

FIG. 15 It depicts an explanatory diagram illustrating an exemplary route search in the primary route search process.

FIG. 16 It depicts an explanatory diagram illustrating an exemplary route search in the primary route search process.

FIG. 17 It depicts an explanatory diagram illustrating an exemplary route search in the secondary route search process.

FIG. 18 It depicts an explanatory diagram illustrating an exemplary route search in the secondary route search process.

FIG. 19 It depicts an explanatory diagram illustrating an exemplary route search in the secondary route search process.

FIG. 20 It depicts an explanatory diagram illustrating a utility calculation result.

FIG. 21 It depicts an explanatory diagram illustrating an application example of utility calculation (addition of an other-occupied area).

FIG. 22 It depicts an explanatory diagram illustrating an application example of utility calculation (addition of an other-occupied area).

FIG. 23 It depicts an explanatory diagram illustrating an application example of utility calculation (reduction of a self-occupied area).

FIG. 24 It depicts an explanatory diagram illustrating an application example of utility calculation (reduction of a self-occupied area).

FIG. 25 It depicts an explanatory diagram illustrating an application example of utility calculation (reduction of a self-occupied area).

FIG. 26 It depicts an explanatory diagram illustrating an application example of utility calculation (exchange of other-occupied and self-occupied areas).

FIG. 27 It depicts an explanatory diagram illustrating an application example of utility calculation (negotiation for exchange).

FIG. 28 It depicts an explanatory diagram illustrating another example of pseudocodes of the primary route search process and the secondary route search process.

FIG. 29 It depicts an explanatory diagram illustrating an example of route search and an example of utility calculation in the secondary route search process.

FIG. 30 It depicts an explanatory diagram illustrating an example of setting negotiation areas.

FIG. 31 It depicts an explanatory diagram illustrating an example of a node map.

FIG. 32 It depicts an explanatory diagram illustrating a pseudocode of an RRT-based optimal route planning algorithm.

FIG. 33 It depicts an explanatory diagram illustrating an example of the node map corresponding to the pseudocode illustrated in FIG. 32.

FIG. 34 It depicts an explanatory diagram illustrating an example of the processing result of the area evaluation algorithm of the second example.

FIG. 35 It depicts an explanatory diagram illustrating an example of route search and utility calculation.

FIG. 36 It depicts an explanatory diagram illustrating an example of movable directions according to the orientation of a mobile object.

FIG. 37 It depicts an explanatory diagram illustrating an example of movable directions according to the position and orientation of a mobile object.

FIG. 38 It depicts an explanatory diagram illustrating an example of movable directions according to the position and orientation of a mobile object.

FIG. 39 It depicts an explanatory diagram illustrating a time extension graph.

FIG. 40 It depicts an explanatory diagram illustrating an example of route search and utility calculation with a time extension graph.

FIG. 41 It depicts an explanatory diagram illustrating an example of route search and utility calculation with a time extension graph.

FIG. 42 It depicts an explanatory diagram illustrating an example of route search and utility calculation with a time extension graph.

FIG. 43 It depicts an explanatory diagram illustrating an example of route search and utility calculation with a time extension graph.

FIG. 44 It depicts a schematic block diagram illustrating a configuration example of a computer according to an exemplary embodiment of the present invention.

FIG. 45 It depicts a block diagram schematically illustrating an area evaluation system of the present invention.

### DESCRIPTION OF EMBODIMENTS

### Exemplary Embodiment 1

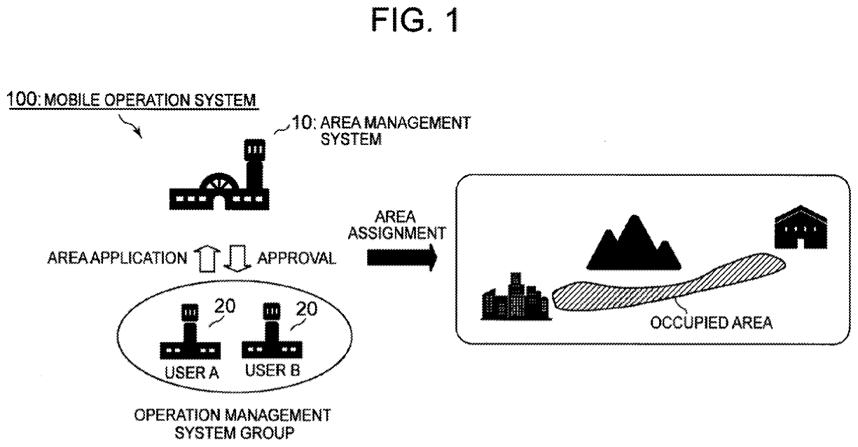

Hereinafter, an exemplary embodiment of the present invention will be described with reference to the drawings. FIG. 1 depicts a schematic configuration diagram of a mobile operation system 100 including an operation management system 20 according to the present exemplary embodiment. Note that an area evaluation system of the present invention is incorporated as one component (area evaluation means 30 described later) of the operation management system 20.

As illustrated in FIG. 1, the operation management system 20 according to the present exemplary embodiment is based on the premise that it belongs to the area management system 10 and manages the operation of a mobile object within a self-occupied area assigned through area application for the area management system 10. Note that a plurality of operation management systems 20 belong to the area management system 10.

It is assumed that the area application for the area management system 10, the creation of an operation plan for a mobile object within the assigned area, area negotiations with the area management system 10 or another operation management system 20, and the like are conducted separately. In the present exemplary embodiment, it is assumed that information regarding these can be referred to as appropriate.

Note that the operation management system 20 does not necessarily belong to the area management system 10. For example, there may be a system configuration in which a plurality of operation management systems 20 are operated independently of the area management system 10.

In the mobile operation system 100, it is assumed that an area is exclusively assigned to each operation management system 20. The operation management of a mobile object in an assigned area is delegated to the assigned operation management system 20. No one except the assigned operation management system 20 can use the area for the operation of a mobile object unless the area itself is obtained through negotiation. By imposing such restrictions on each of the operation management systems 20, conflict between mobile objects of different operation management systems 20 is avoided.

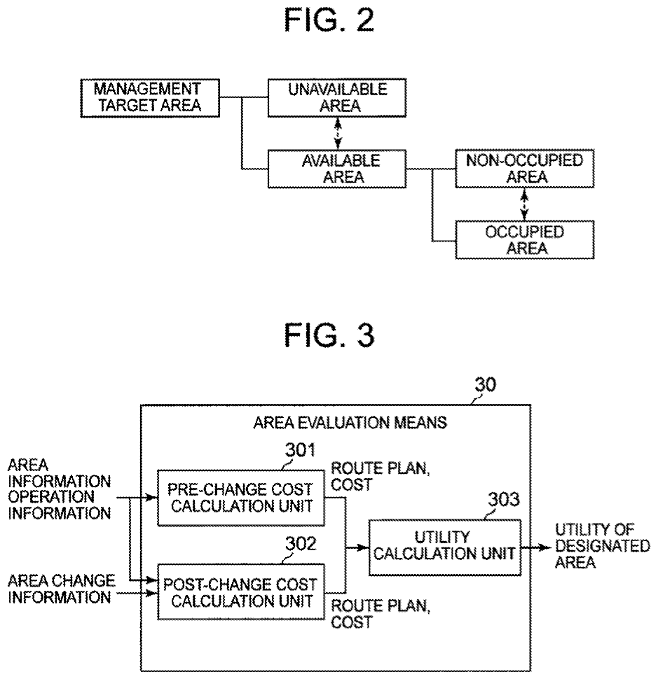

As illustrated in FIG. 2, the management target areas of the area management system 10 are roughly divided into “available areas” and “unavailable areas”. “Available areas” are further roughly divided into “occupied areas” and “non-occupied areas”. Here, an “available area” is an area that can be used for the operation of a mobile object. An “unavailable area” is an area that cannot be used for the operation of a general mobile object due to physical conditions such as buildings and weather or due to emergency response. In other words, “unavailable areas” are areas other than “available areas”. A “non-occupied area” is an “available area” which is not occupied by any operation management system 20. If any operation management system 20 makes a reservation of a “non-occupied area”, this area becomes an “occupied area” of the operation management system 20 in that time period. An “occupied area” is an area that is in use or scheduled to be used by any of the operation management systems 20. Note that an “occupied area” can also be defined as an area assigned to the operation management system 20 for the time period, for example, through application from the operation management system 20.

In the following, from the viewpoint of a certain operation management system 20, an occupied area assigned to itself may be referred to as a “self-occupied area”, and an occupied area assigned to another entity may be referred to as an “other-occupied area”. An “occupied area” which is set as negotiable by the assigned operation management system 20 may be referred to as a “negotiable area”, and an “occupied area” which is set as non-negotiable may be referred to as a “non-negotiable area”. An “occupied area” or “negotiable area” which the operation management system 20 negotiates may be referred to as a “negotiation area”.

FIG. 3 depicts a block diagram illustrating a configuration example of the area evaluation means 30 provided in the operation management system 20 according to the present exemplary embodiment. The area evaluation means 30 according to the present exemplary embodiment uses the following components to calculate, in a case where a route selection area (in this example, self-occupied area) in which a route is selected is increased and/or reduced, the utility of at least a designated area of the post-change route selection area based on the pre-change and post-change operation plans of the mobile object.

In the example illustrated in FIG. 3, the area evaluation means 30 includes a pre-change cost calculation unit 301, a post-change cost calculation unit 302, and a utility calculation unit 303.

For a designated operation plan, using the pre-change route selection area, the pre-change cost calculation unit 301 calculates a travel cost that is based on the operation route in the area. The pre-change route selection area is exemplified by the non-occupied area, the self-occupied area, or a combination thereof confirmed at the present time with respect to the time period associated with the operation plan.

For the designated operation plan, using the post-change route selection area, the post-change cost calculation unit 302 calculates a travel cost that is based on the operation route in the area. Here, the post-change route selection area is an area obtained by changing at least a part of the pre-change route selection area. Note that “changing” an area includes adding an area, reducing an area, and adding and reducing (e.g. exchanging) areas. The post-change route selection area is exemplified by, with respect to the time period associated with the operation plan, (a) an area obtained by adding a part of a non-occupied area or a part of an other-occupied area to the self-occupied area confirmed at the present time, (b) an area obtained by partially reducing the self-occupied area confirmed at the present time, or (c) an area obtained by adding a part of a non-occupied area or a part of an other-occupied area to the self-occupied area confirmed at the present time and partially reducing the self-occupied area.

The utility calculation unit 303 calculates the utility, for the designated operation plan, of a designated area included in the pre-change or post-change route selection area based on the calculation result of the travel cost in the pre-change route selection area and the calculation result of the travel cost in the post-change route selection area.

Here, a travel cost is the evaluation value of a route along which a mobile object moves from the start (departure position) to the goal (arrival position). Better routes have lower travel costs. In the following, a route that can lead to the arrival position at the lowest travel cost under a certain condition may be referred to as the optimal route or optimal solution under the condition. Note that the number of operation routes within the self-occupied area is not limited to one. For example, it is possible to set a plurality of operation routes and calculate a travel cost that is based on each operation route.

For example, a cost function can be used to calculate a travel cost. The cost function is a calculation formula for calculating the travel cost of a designated route. Here, the cost function can include, as its elements, travel distance, travel time, energy consumption, distance from an obstacle to each point on the route, and the like. Note that the cost function may be defined by combining some of these elements. For example, the cost function may be defined as the weighted sum of “travel distance” and “distance from an obstacle”. Depending on the definition of the cost function, the optimal route search solution differs.

In the present exemplary embodiment, the “utility” of an area is defined as a value representing how much “gain” or “loss” the area has for the operation management system. Therefore, the utility of an area for a designated operation plan is a value representing how much “gain” or “loss” the area has for the operation management system in relation to the problem of traveling from the start to the goal indicated in the operation plan. For example, positive utility means that the use of the area can make the cost of travel to the goal lower than a reference travel cost, and negative utility means that the use of the area can make the cost of travel to the goal higher than a reference travel cost. In a case where a plurality of operation plans are designated, whether the post-change travel cost is high or low may be determined using the total of the travel costs of the operation routes set for the designated operation plan group. Alternatively, it may be determined whether the post-change travel cost is higher than the maximum value of travel cost or lower than the minimum value of travel cost.

As a specific example, in a case where a new area becomes available due to a change, if the use of the area makes the travel cost for the operation plan lower than before the change, the new area has positive utility. On the other hand, if the travel cost does not change after the change, the utility of the new area may be zero.

As another specific example, in a case where a part of the current area becomes unavailable due to a change, if the non-use of the area makes the travel cost for the operation plan higher, the part of the area has negative utility. On the other hand, if the travel cost does not change after the change, the utility of the part of the area may be zero.

As another specific example, in a case where a new area becomes available and a part of the current area becomes unavailable due to a change, if the use of the post-change area makes the travel cost lower than before the change, the area on the route used in the post-change area may have positive utility, and the other area may have zero utility. On the other hand, if the use of the post-change area makes the travel cost higher than before the change, the area on the route used in the pre-change area may have negative utility, and the other area may have zero utility. Alternatively, the utility of adding an area may be computed, the utility of reducing the resultant area may be computed, and these utilities may be added up as the utility of the change area (increased and reduced area).

Note that not only the utility of change target areas but also the utility of other areas can be calculated. In that case, if the travel cost in the post-change area is lower than the travel cost in the pre-change area, the area on the route used in the post-change area may have positive utility, and the other area may have zero utility. On the other hand, if the travel cost in the post-change area is higher than the travel cost in the pre-change area, the area on the route used in the pre-change area may have negative utility, and the other area may have zero utility. Note that the utility calculation method is not limited to these.

For example, a utility function can be used for utility calculation. The utility function is a calculation formula for calculating the utility of a designated area. The utility function includes, as its elements, for example, the pre-change travel cost and the post-change travel cost calculated for the pre-change or post-change area including the designated area. An example of the utility function is (pre-change travel cost)−(post-change travel cost). That is, the amount of reduction or increase in travel cost associated with the change may be used as the utility. Hereinafter, “loss” means negative utility.

The pre-change route selection area can be acquired from area information managed by the area management system 10, for example. The post-change route selection area can be acquired from, for example, area information and area change information indicating the area change target generated by an upper processing means or the like in the operation management system 20 which performs area application, area negotiation, or the like. The operation plan can be acquired from, for example, operation information that is information on the operation of the mobile object managed by the operation management system 20. The area (designated area) as a utility calculation target may be determined in advance, such as the change target area or all the pre-change and post-change route selection areas. Alternatively, among these areas, some areas that satisfy a predetermined condition (for example, areas used for an operation route or a candidate therefor before or after the change) may be used as utility calculation targets. Note that the pre-change route selection area, the post-change route selection area, the operation plan, and the designated area can be determined by a request source (e.g. an upper processing means or the like in the operation management system 20 which performs area application, area negotiation, or the like) each time a utility calculation request is issued.

Area information includes at least information indicating the self-occupied area of the operation management system 20. Area information may include, for example, information indicating the status of occupation of the management target area by the operation management system 20 in the time period associated with the acquirable operation plan. Area information may be, for example, information indicating the status of occupied area assignment (including reservation) for each predetermined time period.

Operation information includes at least the departure position and the arrival position for the operation of the mobile object. Note that operation information may be information indicating the current route plan for the operation of the mobile object, and may further include information indicating the currently-planned operation route, the travel cost of the operation route, and restrictions such as the arrival time and waypoints. In a case where the travel cost in the pre-change route selection area can be acquired from operation information, the pre-change cost calculation unit 301 can be omitted.

The operation management system 20 may also include an information holding means (not illustrated) that holds operation information of the mobile object managed by itself and a data receiving means (not illustrated) that receives area information managed by the area management system 10.

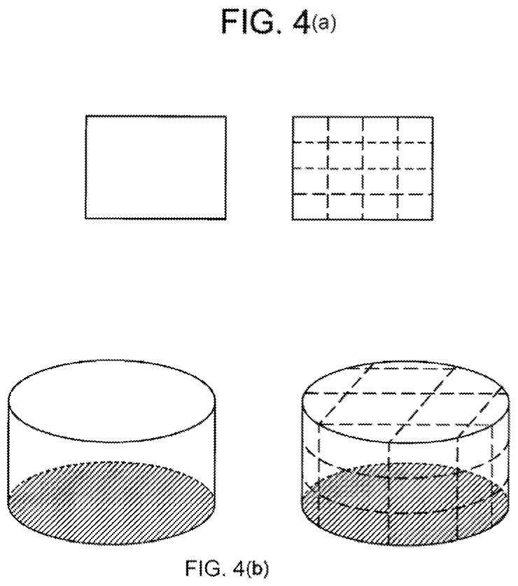

In the present exemplary embodiment, a two-dimensional or three-dimensional space is assumed as an area used for the operation of a mobile object. Then, the space is divided into predetermined management units, each of which is defined as one unit of “area” (or “airspace”). Each area is exclusively assigned to the operation management system 20. FIG. 4(a) is an explanatory diagram illustrating an example of areas defined in a two-dimensional space, and FIG. 4(b) is an explanatory diagram illustrating an example of areas defined in a three-dimensional space.

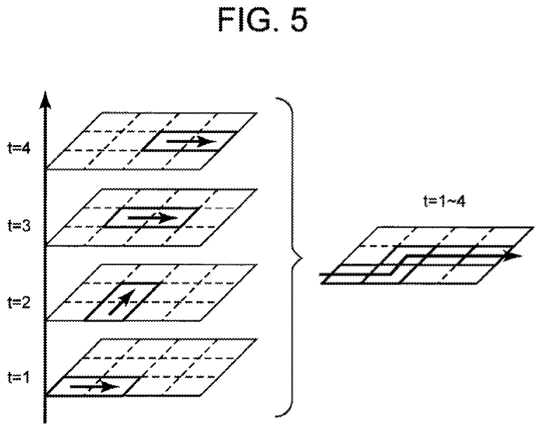

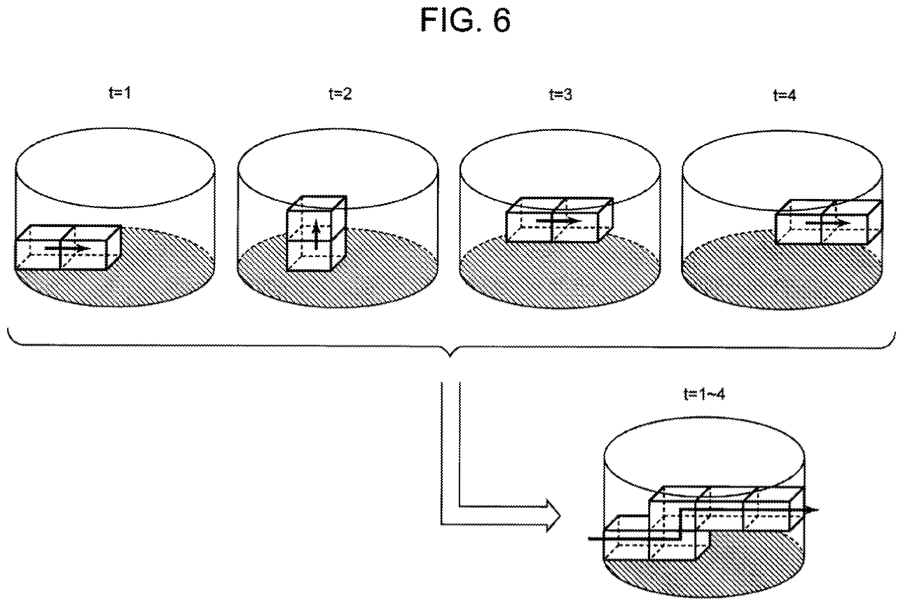

As illustrated in FIG. 5, areas are assigned in each time, and each operation management system 20 forms a route by selecting, from among the areas assigned to itself, an area adjacent to the area where the mobile object is currently located. In the following, for the sake of simplicity, a two-dimensionally extending area is described as an example of the operation route of a mobile object. However, those skilled in the art can easily understand that the route can be applied to a three-dimensionally extending area (see FIG. 6).

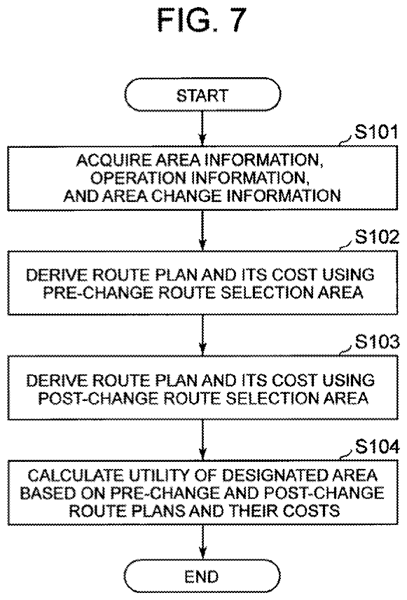

Next, the operation of the area management system 10 according to the present exemplary embodiment will be described. FIGS. 7 to 9 depict flowcharts illustrating examples of the operation of the area evaluation means 30.

In the example illustrated in FIG. 7, first, the area evaluation means 30 acquires area information, operation information, and area change information (step S101).

Next, the pre-change cost calculation unit 301 of the area evaluation means 30 derives a route plan for a designated operation plan using the pre-change route selection area, and calculates its travel cost (step S102).

Next, the post-change cost calculation unit 302 of the area evaluation means 30 derives a route plan for the designated operation plan using the post-change route selection area, and calculates its travel cost (step S103). Note that step S103 can be performed prior to step S102. Alternatively, step S102 and step S103 can be performed in parallel.

Next, the utility calculation unit 303 of the area evaluation means 30 calculates the utility of a designated area based on the pre-change and post-change route plans and their travel costs (step S104).

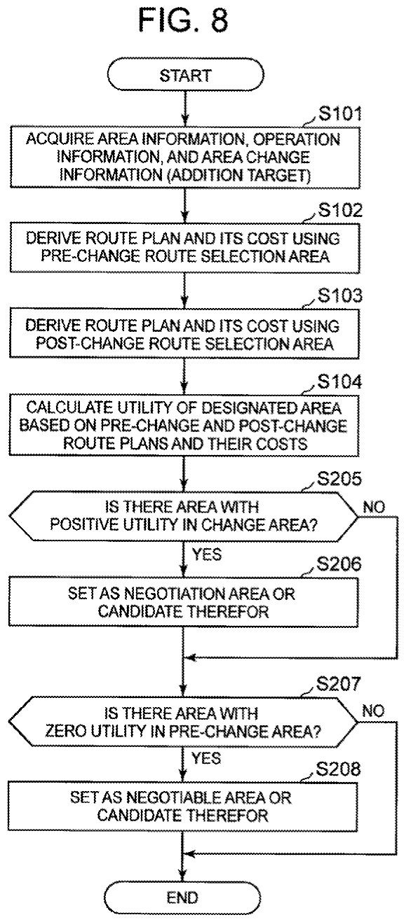

FIG. 8 depicts a flowchart illustrating an example of the operation of the area evaluation means 30 for the case that the route selection area is increased. Note that steps S101 to S104 are the same as those in FIG. 7, and descriptions thereof are omitted. However, in this example, information indicating the addition target area is input as area change information. The designated area is the addition target area or the post-change route selection area including the addition target area.

In the example illustrated in FIG. 8, after the utility of the designated area is calculated, the area evaluation means 30 determines whether there is an area with positive utility in the change area (the addition target area in this example) (step S205). If there is an area with positive utility in the change area (Yes in step S205), the area is set as a negotiation area or a candidate therefor (step S206).

The area evaluation means 30 may also determine whether there is an area with zero utility in the pre-change route selection area (step S207). Note that step S207 is a process for determining the presence or absence of an area that will no longer be used due to the change. If there is such an area (Yes in step S207), the area may be set as a negotiable area or a candidate therefor (step S208).

The area evaluation means 30 may also determine (not illustrated) whether a part of the post-change route selection area is also included in the pre-change route selection area and has positive utility. Note that this process is a process for determining the presence or absence of a pre-change area that will continue to be used after the change. If there is such an area, the area may be set as a non-negotiable area or a candidate therefor.

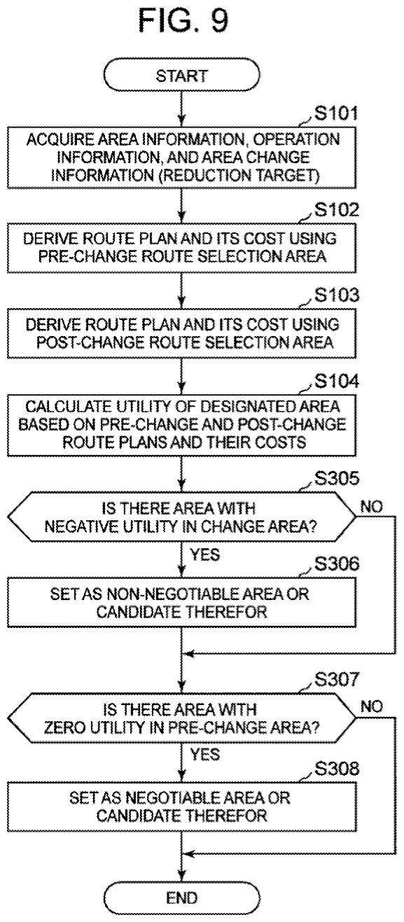

FIG. 9 is a flowchart illustrating an example of the operation of the area evaluation means 30 for the case that the route selection area is reduced. Note that steps S101 to S104 are the same as those in FIG. 7, and descriptions thereof are omitted. However, in this example, information indicating the reduction target area is input as area change information. The designated area is the reduction target area or the pre-change route selection area including the reduction target area.

In the example illustrated in FIG. 9, after the utility of the designated area is calculated, the area evaluation means 30 determines whether there is an area with negative utility in the change area (the reduction target area in this example) (step S305). If there is such an area (Yes in step S305), the area is set as a non-negotiable area or a candidate therefor (step S306).

The area evaluation means 30 may also determine whether there is an area with zero utility in the pre-change route selection area (step S307). Note that step S307 is a process for determining the presence or absence of an existing area that will not be used after the change. If there is such an area (Yes in step S307), the area may be set as a negotiable area or a candidate therefor (step S308).

The area evaluation means 30 may also determine (not illustrated) whether there is an area with negative utility in the pre-change route selection area, not only in the change area. If there is such an area, the area may be set as a non-negotiable area or a candidate therefor.

Next, a utility calculation method and its application examples will be described with reference to specific examples. First, the A* (A-star) method used in specific examples will be briefly described.

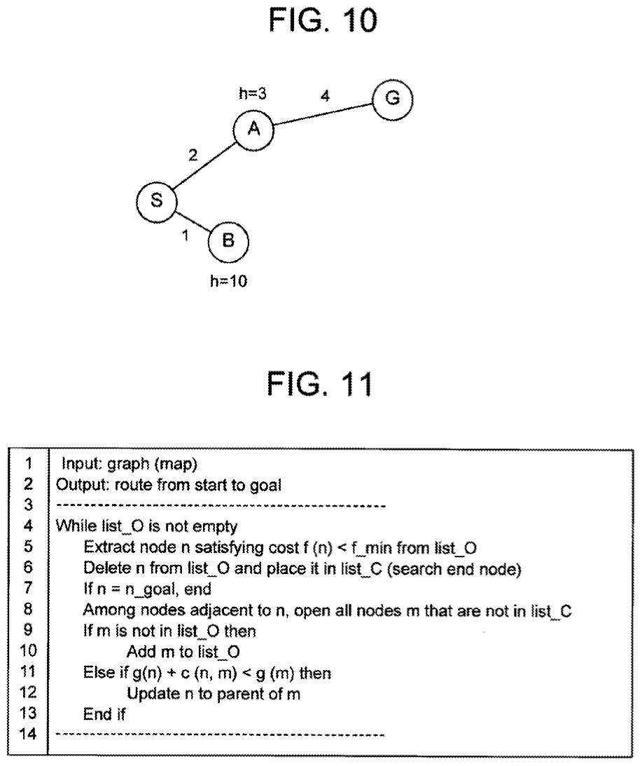

The A-star method is one of the optimal route planning algorithms. For example, suppose that there is a node map (graph representation of areas) as illustrated in FIG. 10. Here, a circle represents a node, and the number in a circle represents a node identifier. Note that S is the start and G is the goal. Each node corresponds to any one area (management unit area) in the route selection area. A line (referred to as an edge or branch) connecting nodes represents the route of movement between the nodes, and the number attached on a route represents the cost (travel cost) required for movement on the route.

In this case, the evaluation function f (n) of an arbitrary node n on the map is expressed as follows. Here, the evaluation function f (n) corresponds to the above-described cost function (for the route from the start to n). In addition, g (n) represents the cost of the route from n to the start, and h (n) represents the estimated cost of the route from n to the goal. In addition, h*(n) represents the actual cost of the route from n to the goal.

f(n)=g(n)+h(n) (1)

In a case where this function is applied to the example illustrated in FIG. 10, the evaluation value f (A) of the node A is g (A)+h (A)=2+3=5. The evaluation value f (B) of the node B is g (B)+h (B)=1+10=11. The evaluation value f (G) of the node G is g (G)+h (G). In this case, as the result of the search for the route to G, g (G) is updated to g (A)+c (A, G)=2+4=6. Therefore, f (G) can be calculated as 6+0=6. In the A-star method, an optimal solution is guaranteed when h (n)≤h*(n) is satisfied. Here, c (a, (3) represents the actual cost of the route between α and β.

FIG. 11 depicts an explanatory diagram illustrating a pseudocode of the simple A-star-based optimal route planning algorithm. The optimal route planning algorithm illustrated in FIG. 11 receives a graph of a route selection area in which a start-goal pair is designated, and outputs a route from the start to the goal. Note that the processing starts from the fourth line.

In the fourth line, the processes in the fifth to thirteenth lines are repeated until the open list O that stores search target nodes becomes empty, and the processing ends when the open list O becomes empty. As a preprocess for the fourth line, the open list O stores one start node. In this example, it is assumed that h ( ) of each node is known, but g ( ) of each node is unknown. Note that g ( ) is calculated based on the evaluation value f ( ) of a parent node and the travel cost e (parent, current) from the parent node to the current node when nodes are sequentially sought from the start. As an initial value, the value of f_min indicating the current minimum evaluation value is set as a value indicating the maximum in the open list O.

In the fifth line, a node n satisfying cost f (n)<f_min is extracted from the open list O. Next, in the sixth line, the node n is deleted from the open list O and placed in the closed list C that stores search end nodes. Next, in the seventh line, if the node n is the goal node, the while loop is terminated, and the processing is ended. Otherwise, the processing goes to the eighth line.

In the eighth line, among the nodes adjacent to n, all the nodes m that are not in the closed list C are opened (extracted from the map).

Next, in the ninth line, it is determined whether the node m is in the open list O. If not, in the tenth line, f (m) is calculated based on f (n) of the current node n and the cost c (n, m), and the node m is added to the open list O. At this time, n is assumed as the parent of m. Here, c (n, m) represents the cost of travel between n and m.

In the eleventh line, while the node m is in the open list O, it is determined whether g (n)+c (n, m)<g (m) is satisfied. If so, in the next twelfth line, n which can lead to m at a lower cost is updated to the parent of m. Here, f (m) is also updated based on f (n) of the current node n and the cost c (n, m).

As illustrated in the thirteenth line, if the node m is in the open list O and does not satisfy the above condition, nothing is performed.

After the series of processes from the fifth line to the thirteenth line is completed, the processing returns to the fourth line.

By repeating the above processing until the open list O becomes empty (until the entire map is searched), a node tree indicating the shortest route or no route in the closed list C is finally created. Therefore, if the node tree can be traced from the goal through parents to the start, the optimal solution can be obtained. If the open list O becomes empty but a route that leads to the goal cannot be found, the search is considered a failure. Note that the above repeating can be terminated before the open list O becomes empty if the route to the goal is found and there are no other lower cost nodes in the open list.

Next, the area evaluation algorithm of this example will be described. The area evaluation algorithm of this example calculates the utility of the change area using a route search algorithm obtained by extending the A-star-based optimal route planning for area evaluation.

The outline is as follows. In the area evaluation algorithm of the first example, first, a route search is performed in the pre-change route selection area using the A-star-based optimal route planning algorithm, and the optimal route and its cost are derived (primary route search process). Next, a route re-search is started at the minimum cost node of the nodes adjacent to change nodes in the area subjected to the route search (secondary route search process). The secondary route search process may be ended at the time that the minimum cost route is found in the post-change route selection area. Finally, the utility of the change area is calculated using Formula (2) below.

Utility of change area=Cost of optimal route in pre-change route selection area (before area addition)−Post-change minimum cost (2)

Here, the route selection area before area addition may be, for example, a non-occupied area. The additional area may be an other-occupied area or a negotiable area of another entity. Formula (2) can be applied only to the area on the route in the route selection area after area addition in the change area. In that case, the utility of the area other than the area on the route may be zero.

The above algorithm can also be applied to area reduction. This application is achieved simply by replacing the above “route selection area after area addition” with “route selection area before reduction” (that is, the wider one of the pre-change and post-change route selection areas), and replacing the above “route selection area before area addition” with “route selection area after reduction” (that is, the narrower one of the pre-change and post-change route selection areas).

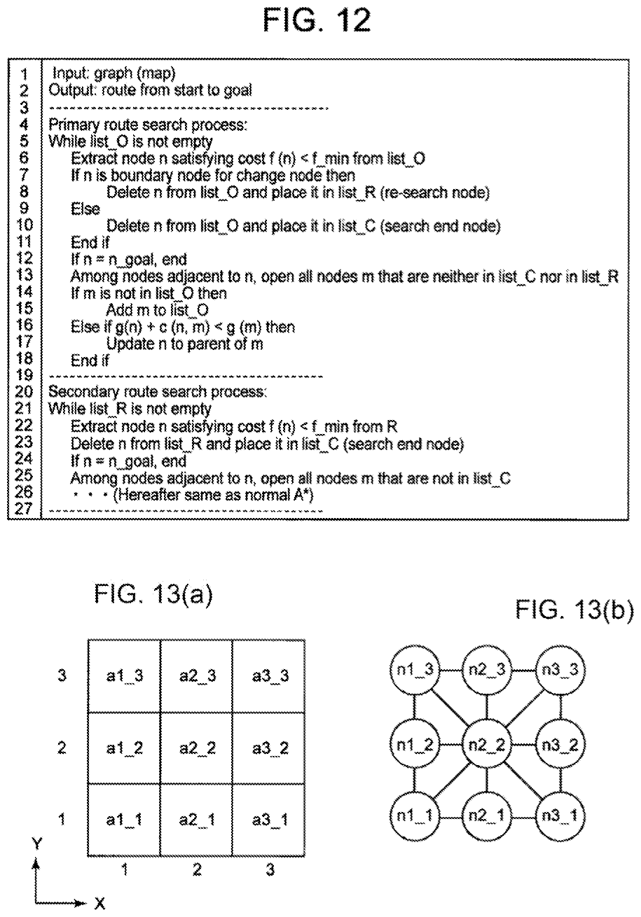

FIG. 12 depicts an explanatory diagram illustrating pseudocodes of the primary route search process and the secondary route search process used in the area evaluation algorithm of this example. In the following, differences from the A-star-based optimal route planning algorithm illustrated in FIG. 11 will be mainly described.

In the primary route search process, the seventh and eighth lines are added. Here, the seventh line determines whether the extracted node n is subject to a re-search in the secondary route search process. Here, it is determined whether the node n is a node adjacent to a change node. If so, in the next eighth line, the node n is added to the re-search list R, not to the closed list C. Here, the change node is a node corresponding to the change area. For example, the change node is an additional node corresponding to the additional area or a reduction node corresponding to the reduction area.

The thirteenth line specifies an additional condition that a node m be neither in the closed list C nor in the re-search list R.

On the other hand, the secondary route search process is the same as the A-star-based optimal route planning algorithm illustrated in FIG. 11, except that the re-search list R is used as the search target open list, instead of the open list O.

As described above, by using the result of the primary route search process, the time required for the route search process after the area addition can be reduced.

Next, the area evaluation algorithm of this example will be described in more detail by presenting cost calculation results using two-dimensional maps. In the following, nodes (areas) in a map are identified as follows. FIG. 13 depicts an explanatory diagram illustrating an example of the identifiers and graph representation of areas in a map. As illustrated in FIG. 13(a), the map is a two-dimensional map in which management unit areas are two-dimensionally connected in the X direction and the Y direction. In the drawing, the lower left area is referred to as the area a1_1, the area connected to the area a1_1 in the positive X direction is referred to as the area a2_1, and the area connected to the area a1_1 in the positive Y direction is referred to as the area a1_2. The node corresponding to the area a1_1 is referred to as the node n1_1. Here, the first number of an area identifier and a node identifier represents the x coordinate, and the second number represents the y coordinate.

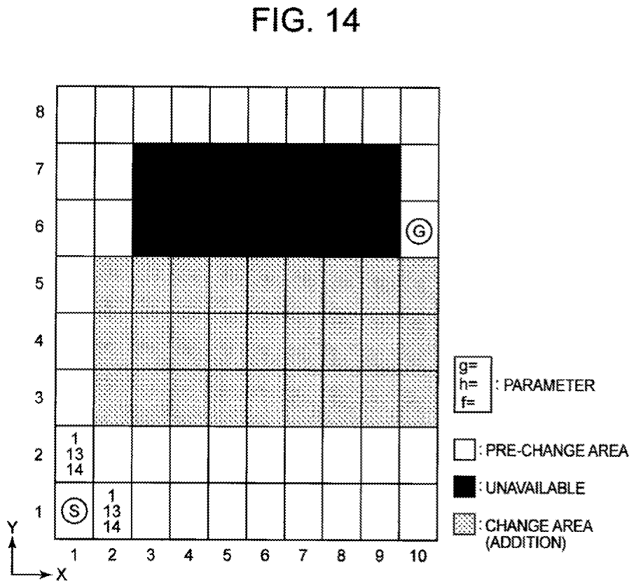

Now, suppose that there is a 10×8 area as illustrated in FIG. 14. The attributes of the areas in the map are as illustrated in the drawing. Then, suppose that (S, G)=(n1_1, n10_6) is given as a start-goal pair for a route search according to the operation plan.

In this example, movement is allowed only in four directions (positive X direction, negative X direction, positive Y direction, and negative Y direction). The Manhattan distance is used for h ( ).

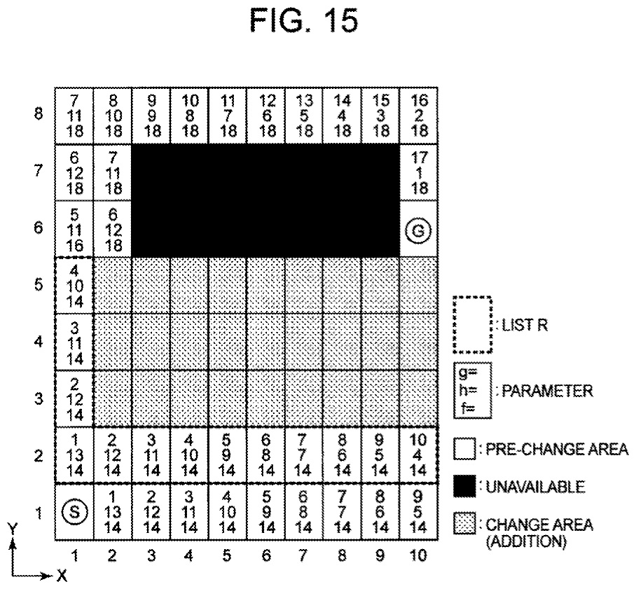

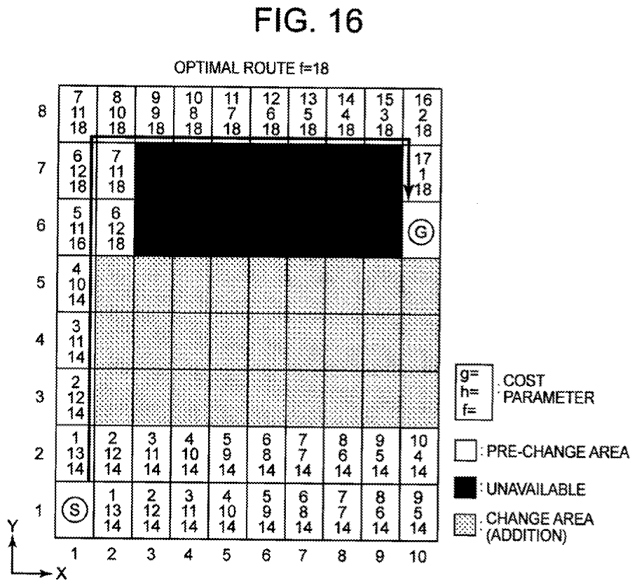

FIGS. 15 and 16 depict explanatory diagrams illustrating an exemplary route search in the primary route search process. In the primary route search process, the pre-change route selection area is searched for a route. First, the node n1_1 that is the start node is selected as a node n. Then, the adjacent nodes n2_1 and n1_2 are selected as nodes m, and parent nodes and costs are given (see FIG. 15).

Next, the nodes n2_1 and n1_2 with the minimum cost are selected as nodes n from among the nodes for which a parent node has already been set and a destination search has not been completed. Then, parent nodes and costs are given to the nodes n2_2, n1_3, and n3_1 adjacent to the nodes n2_1 and n1_2. In a case where there are a plurality of nodes n with the minimum cost, it is only necessary to perform, for each of the nodes n with the minimum cost, the process of searching for an adjacent node and assigning a parent node and a cost to the adjacent node.

The above process is repeated until there is no other search target node. When the node n10_6 that is the goal node is reached, the shortest route is obtained as illustrated in FIG. 16. Based on f (n10_7) of the parent node of the goal node, the cost of the optimal route in this example, that is, the cost of the pre-change optimal route, is f (G)=f (n10_7)+0=18.

In the primary route search process, when a node n is selected, if the node n is a node adjacent to an additional node, the node n is held as a re-search node (added to the re-search list R). FIG. 15 also depicts an example of nodes that are added to the re-search list R (see the dotted frame in the drawing).

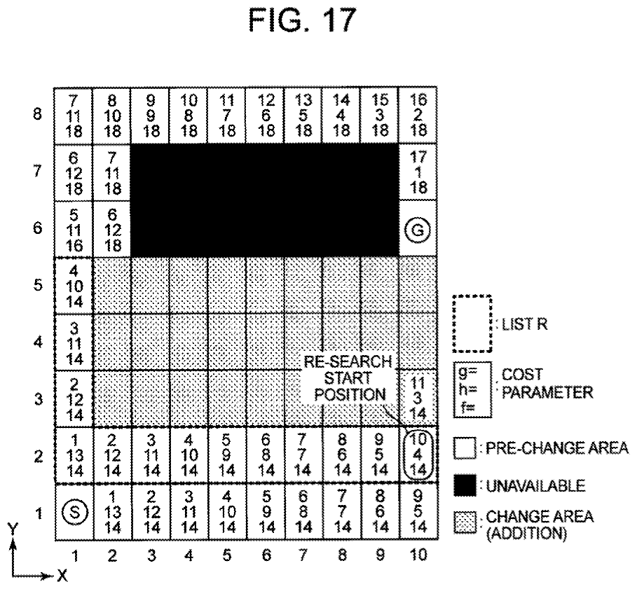

FIGS. 17 to 19 depict explanatory diagrams illustrating an exemplary route search in the secondary route search process. In the secondary route search process, a search target node is selected from the re-search list R created in the primary route search process. In this example, first, a node with the minimum cost (the nodes indicated by the dotted frame in FIG. 15) is selected as a node n from the re-search list R. When there are a plurality of nodes n with the minimum cost, for example, the node n having the minimum estimated distance h to the goal may be selected. After the node n is selected, it is only necessary to search the target area according to the normal A-star algorithm (see FIG. 17).

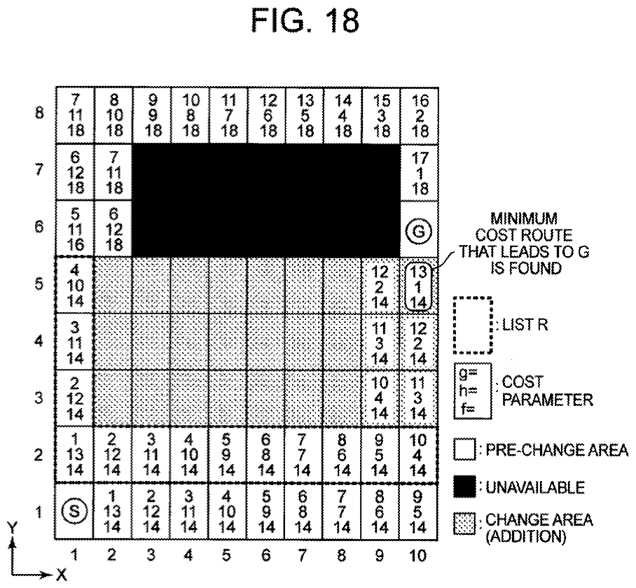

In the secondary route search process, the route re-search can be ended at the time that the minimum cost route that leads to the goal is found (see FIG. 18).

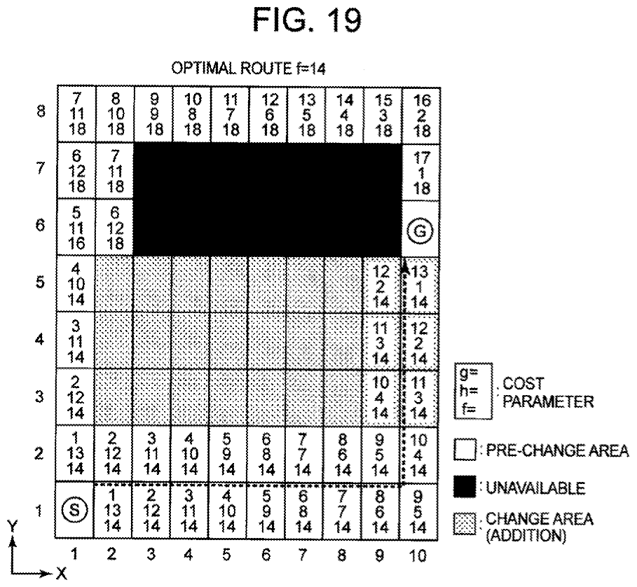

Note that FIG. 19 depicts the optimal route in the post-change route selection area found as the result of the secondary route search process. In this example, based on f (n10_5) of the parent node of the goal node, the post-change minimum cost is f (G)=f (n10_5)+0=14.

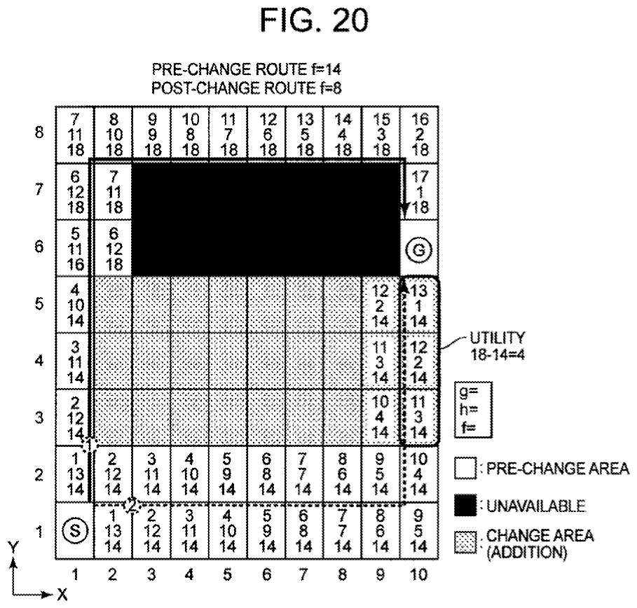

FIG. 20 depicts an explanatory diagram illustrating a utility calculation result. As illustrated in FIG. 20, from the above results, the utility of the three areas (areas a10_3, a10_4, and a10_5) on the post-change route in the change area is calculated using Formula (2) above as pre-change f (G)−post-change f (G)=18−14=4.

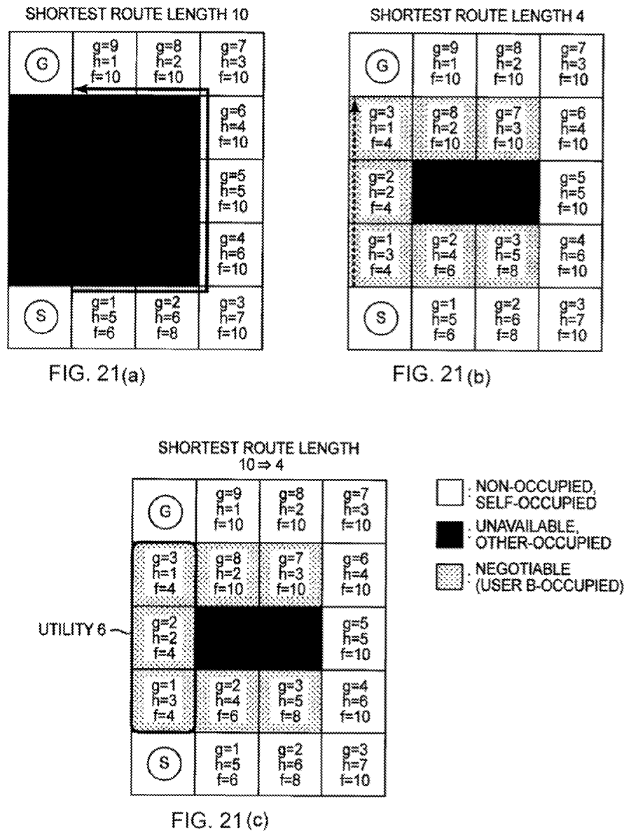

Next, some application examples of utility calculation will be described with reference to FIGS. 21 to 27. FIG. 21 depicts a utility calculation example for the case that an other-occupied area is added under the assumption that occupied areas are negotiated between two operation management systems. FIG. 21(a) is an explanatory diagram illustrating the optimal route and its cost in the pre-change route selection area. Now, suppose that the area assignment and the operation plan illustrated in FIG. 21(a) have been made in a 4×5 area. The cost of the optimal route in this example is f (G)=10. Note that FIG. 21 depicts the attributes of the areas from the viewpoint of the user A, i.e. one of the operation management systems 20 or its business operator.

FIG. 21(b) is an explanatory diagram illustrating the optimal route and its cost in the post-change route selection area. The cost of the optimal route in this example is f (G)=4. The change area (additional area) in this example is the “negotiable (user B-occupied)” area in the drawing.

FIG. 21(c) is an explanatory diagram illustrating an example of a negotiation area and its utility based on the above results. In the example illustrated in FIG. 21(c), the area with positive utility in the change area, that is, the area on the post-change route, is set as a negotiation area, and its utility is calculated. Specifically, the three areas a1_2, a1_3, and a1_4 are set as a negotiation area, and its utility is calculated as 10−4=6. The utility function in this example is a change in route length due to the exclusion of the occupation by the other entity.

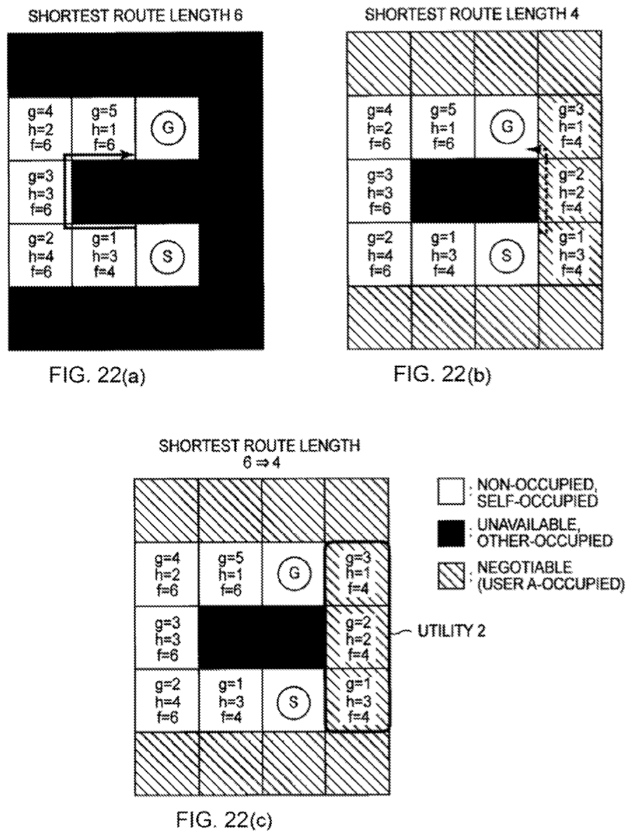

FIG. 22 depicts a utility calculation example, from the viewpoint of the user B, for the case that an other-occupied area is added under the assumption that occupied areas are negotiated between two operation management systems. In FIG. 22, the attributes of the areas are depicted from the viewpoint of the user B, i.e. one of the operation management systems 20 or its business operator different from the user A. Note that FIG. 22(a) is an explanatory diagram illustrating the optimal route and its cost in the pre-change route selection area. Now, suppose that the area assignment and the operation plan illustrated in FIG. 22(a) have been made in a 4×5 area. The cost of the optimal route in this example is f (G)=6.

FIG. 22(b) is an explanatory diagram illustrating the optimal route and its cost in the post-change route selection area. The cost of the optimal route in this example is f (G)=4. The change area (additional area) in this example is the “negotiable (user A-occupied)” area in the drawing.

FIG. 22(c) is an explanatory diagram illustrating an example of a negotiation area and its utility based on the above results. In the example illustrated in FIG. 22(c), similarly, the area with positive utility in the change area, that is, the area on the post-change route, is set as a negotiation area, and its utility is calculated. Specifically, the three areas a4_2, a4_3, and a4_4 are set as a negotiation area, and its utility is calculated as 6−4=2. The utility function in this example is also a change in route length due to the exclusion of the occupation by the other entity.

Although the utility calculation examples for area addition have been described above, the area may be reduced. In the following, we consider how much loss partial passing of the self-occupied area (current route selection area) causes to the operation plan of the operation management system.

The calculation of the loss may be performed as follows, for example. First, it is determined whether the original solution (pre-change expected route) is included in the target area (change area). If it is not included, there will be no impact on the operation plan of the operation management system, so the loss in this area is zero.

If it is included, a candidate for another solution is sought using the post-change route selection area (after reduction). At this time, a new search may be performed, or a search can be performed with reference to past calculation results held. If a candidate for another solution (alternative route) is found, the loss due to passing of the target area is calculated using Formula (3) below. If no other solution is found, the target area is considered not negotiable (for example, loss is infinite).

Loss of target area=Cost of alternative route−Cost of pre-change route (3)

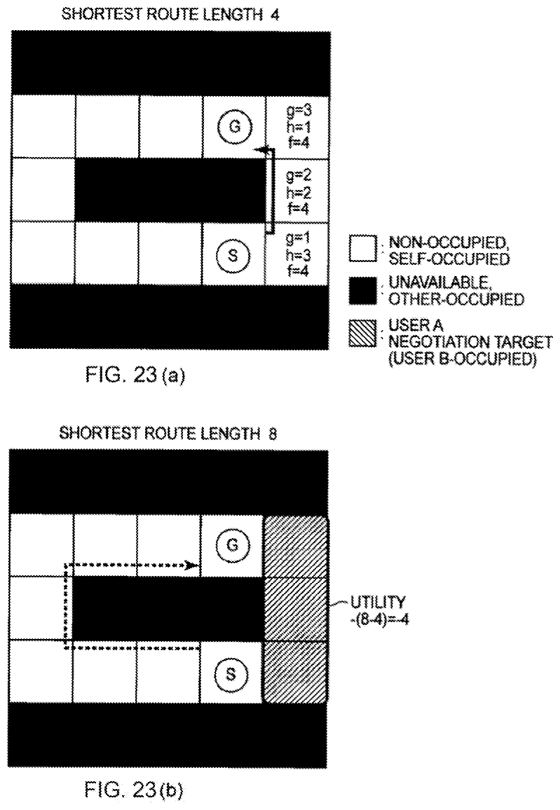

FIGS. 23 to 25 depict utility (loss) calculation examples associated with partial passing of the self-occupied area in response to a request from the other entity.

First, the loss calculation example in FIG. 23 will be described. FIG. 23(a) is an explanatory diagram illustrating the optimal route and its cost in the pre-change route selection area. Now, suppose that the area assignment and the operation plan illustrated in FIG. 23(a) have been made in a 5×5 area. The optimal route in this example is as illustrated in the drawing, and its cost is f (G)=4. FIG. 23(b) is an explanatory diagram illustrating the optimal route and its cost in the post-change route selection area (when the area is passed). The optimal route in this example is as illustrated in the drawing, and its cost is f (G)=8.

The loss (negative utility) of the change area in such a case is computed as follows, for example. That is, since the original solution (pre-change expected route) is included in the target area (change area) and another solution is found, the loss of the target area is calculated as 8−4=4. Note that the utility of the target area in this case is −(8−4)=−4.

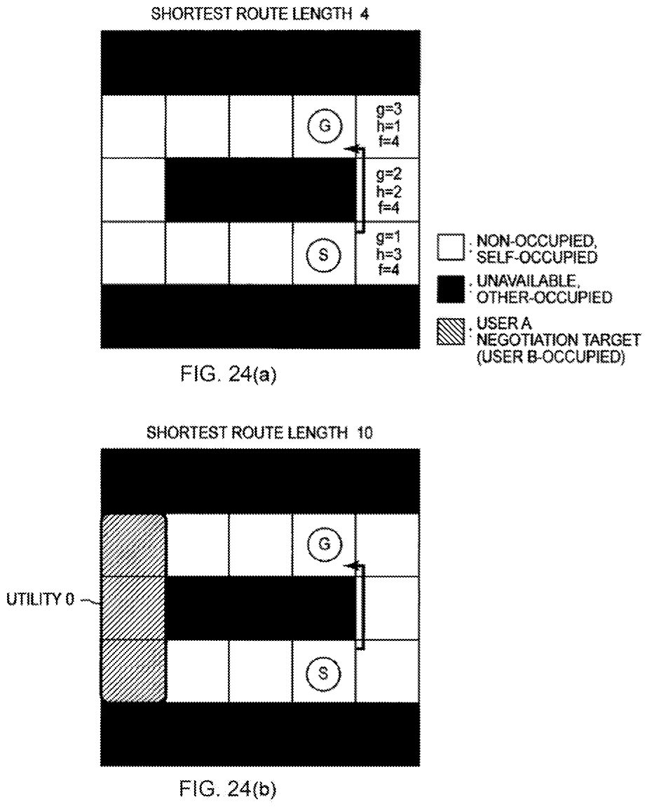

FIG. 24 depicts an explanatory diagram illustrating a loss calculation example for the case that the original solution (pre-change expected route) is not included in the target area (change area). FIG. 24(a) is an explanatory diagram illustrating the optimal route and its cost in the pre-change route selection area. Now, suppose that the area assignment and the operation plan illustrated in FIG. 24(a) have been made in a 5×5 area. The optimal route in this example is as illustrated in the drawing, and its cost is f (G)=4. FIG. 24(b) is an explanatory diagram illustrating the optimal route in the post-change route selection area (when the area is passed).

As illustrated in FIGS. 24(a) and (b), in this example, the original solution (pre-change expected route) is not included in the target area (change area). Therefore, the loss of the target area is calculated as zero. Note that the utility of the target area in this case is −(0)=0.

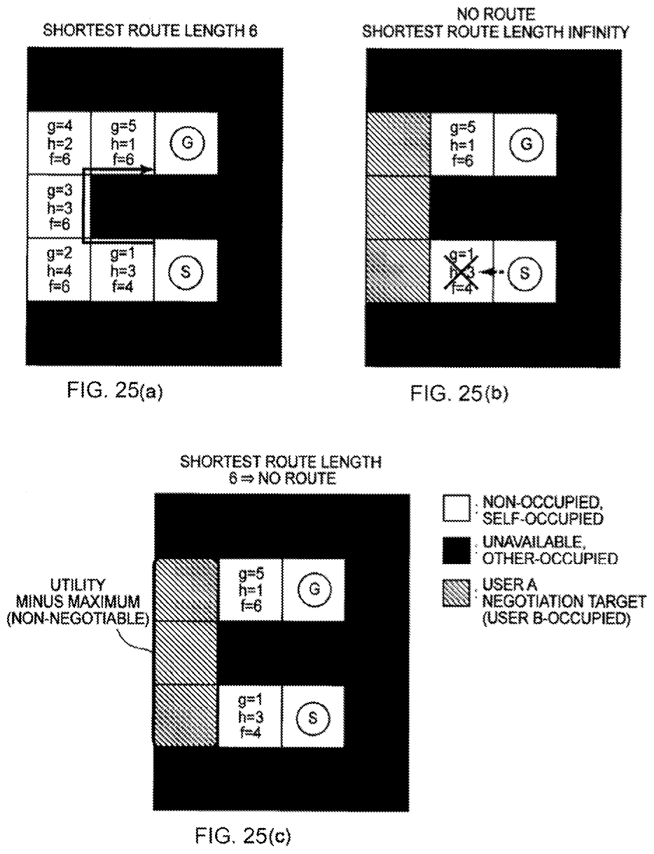

FIG. 25 is an explanatory diagram illustrating a loss calculation example for the case that the original solution (pre-change expected route) is included in the target area (change area) and there is no other solution. FIG. 25(a) is an explanatory diagram illustrating the optimal route and its cost in the pre-change route selection area. Now, suppose that the area assignment and the operation plan illustrated in FIG. 25(a) have been made in a 4×5 area. The cost of the optimal route in this example is f (G)=6.

FIG. 25(b) is an explanatory diagram illustrating the optimal route in the post-change route selection area (when the area is passed). It is an explanatory diagram illustrating the optimal route and its cost in the post-change route selection area. In this example, since the original solution (pre-change expected route) is included in the target area (change area), another solution is sought. However, no solution is found, so the cost is considered infinite.

In FIG. 25, the attributes of the areas are depicted from the viewpoint of the user B, and the change area is a part of the self-occupied area of the user B.

FIG. 25(c) is an explanatory diagram illustrating an example of setting a non-negotiable area and its utility based on the above results. That is, since the original solution (pre-change expected route) is included in the target area (change area) and no other solution is found, the target area is set as a non-negotiable area.

Note that its utility may be minus infinity as illustrated in FIG. 25(c). Alternatively, for example, the utility of the target area can be 0−pre-change cost, and the target area can be set as a negotiation area as it is. This enables the negative utility (loss) to be used as an index for securing another area that compensates therefor.

In a case where the area is reduced, when the post-change route selection area is searched for an alternative route, another area (non-occupied area or other-occupied area) can be added to the post-change route selection area. Note that other-occupied areas include occupied areas, negotiable areas, and the like of the negotiating partner or other users.

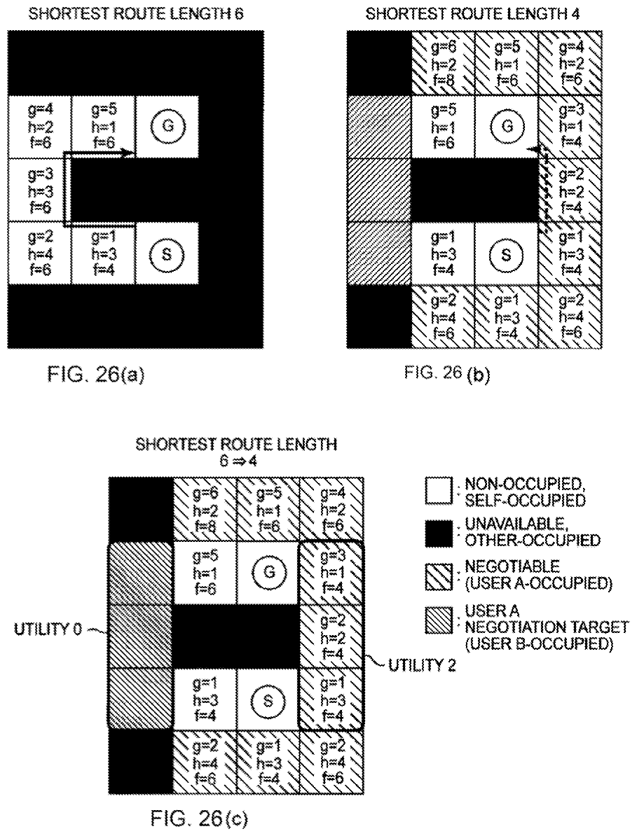

FIG. 26 depicts a utility calculation example for the case that the self-occupied area is reduced and an other-occupied area is added (occupied areas are exchanged) under the assumption that occupied areas are negotiated between two operation management systems. FIG. 26(a) is an explanatory diagram illustrating the optimal route and its cost in the pre-change route selection area. Now, suppose that the area assignment and the operation plan illustrated in FIG. 26(a) have been made in a 4×5 area. The cost of the optimal route in this example is f (G)=6. In FIG. 26, the attributes of the areas are depicted from the viewpoint of the user B.

FIG. 26(b) is an explanatory diagram illustrating the optimal route and its cost in the post-change route selection area. The cost of the optimal route after the reduction of the self-occupied area and the addition of the other-occupied area in this example is f (G)=4. Note that the change areas (additional area and reduction area) in this example are the “negotiable (user A-occupied)” area and the “user A negotiation target (user B-occupied)” area in the drawing. Note that this example assumes that the “user A negotiation target (user B-occupied)” area is requested from the user A as the first step of negotiation, and then at least a part of the “negotiable (user A-occupied)” area is requested in exchange for the area.

FIG. 26(c) is an explanatory diagram illustrating an example of the utility of each change area based on the above results. In the example illustrated in FIG. 26(c), the utility of the reduction area and the utility of the increase area in the change areas are calculated separately. In this example, since an alternative route is found in the increase area, the utility on the route in the increase area is positive, and the utility in the reduction area is zero. Specifically, for the three areas a1_2, a1_3, and a1_4 that are the reduction area, the utility is calculated as zero, and for the three areas a4_2, a4_3, and a4_4 that are the increase area, the utility is calculated as 6−4=2.

Note that the above example is an example in which the post-change cost is reduced and the post-change route is not included in the reduction area. For example, in a case where the post-change cost is increased, the utility of the reduction area may be minus infinity (or 0−pre-change cost), and the cost of the increase area may be zero. For example, in a case where the post-change cost is reduced and the post-change route is included in the reduction area, the utility of the area on the route may be minus infinity (or 0−pre-change cost).

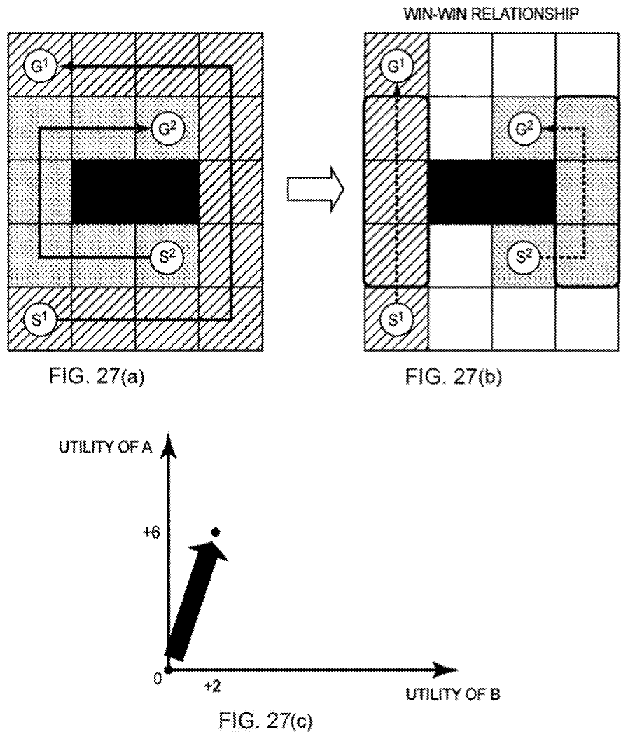

FIG. 27 is an explanatory diagram illustrating an example of pre-change and post-change optimal routes and their costs for the case that the user A and the user B exchange their negotiation areas. As illustrated in FIG. 27, proper evaluation of the utility of the negotiation area presented by the other entity and the utility of the negotiable area of the other entity makes it easier to conclude the negotiation and consequently to achieve a mutually beneficial area exchange.

FIG. 27(a) depicts the pre-exchange route plans of the user A and the user B, and FIG. 27(b) depicts the post-exchange route plans of the user A and the user B. FIG. 27(c) depicts the utilities that the user A and user B obtain due to the exchange. In practice, route plans and utilities of the negotiating partner are often hidden. Therefore, by appropriately evaluating the intrinsic values of areas for the operation management system (utilities for the operation plan of the operation management system), adverse negotiations can be prevented, and negotiations can be conducted in an advantageous manner.

In the above examples, the secondary route search process is ended at the time that the optimal route is found in the post-change route selection area. Alternatively, a plurality of routes can be derived in the post-change route selection area, and the cost and utility of each of the routes can be computed.

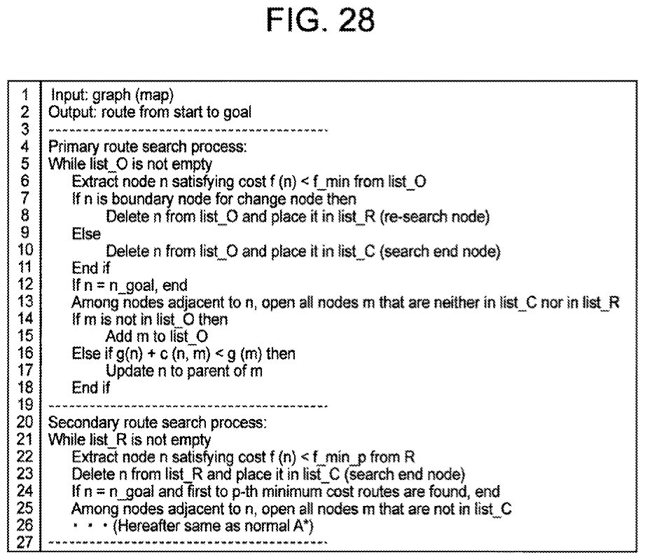

FIG. 28 depicts an explanatory diagram illustrating another example of pseudocodes of the primary route search process and the secondary route search process. In the following, differences from the pseudocodes illustrated in FIG. 12 will be mainly described. Note that the pseudocode of the primary route search process is the same as the pseudocode illustrated in FIG. 12.

The 22nd and 24th lines in the secondary route search process of this example are different from those of the example in FIG. 12. The 22nd line of this example takes, from the re-search list R, a node n with a cost smaller than the variable f_min_p holding the first to p-th minimum costs. Here, f_min_1≤f_min_2<<f_min_p is satisfied. In this example, as well as the first to p-th minimum costs, the corresponding nodes are held.

The 24th line indicates search end conditions. In this example, if the node n is the goal node and the first to p-th minimum cost routes are found, the while loop is terminated, and the processing is ended.

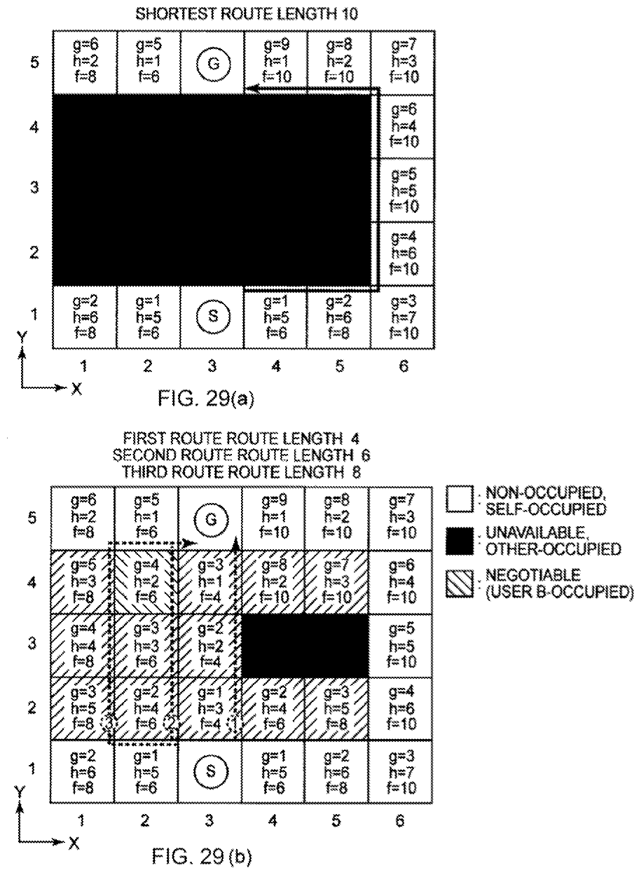

FIG. 29 depicts an explanatory diagram illustrating an example of route search and an example of utility calculation in the secondary route search process. FIG. 29(a) is an explanatory diagram illustrating the optimal route and its cost in the pre-change route selection area. Now, suppose that the area assignment and the operation plan illustrated in FIG. 29(a) have been made in a 6×5 area. The cost of the optimal route in this example is f (G)=10.

FIG. 29(b) is an explanatory diagram illustrating the first to third (p=3) minimum cost routes and their costs in the post-change route selection area. The first minimum cost route (optimal route) in this example is the route indicated by the dotted circle 1 in the drawing, and its cost is f₁ (G)=4. The second minimum cost route in this example is the route indicated by the dotted circle 2 in the drawing, and its cost is f2 (G)=6. The third minimum cost route in this example is the route indicated by the dotted circle 3 in the drawing, and its cost is f3 (G)=8.

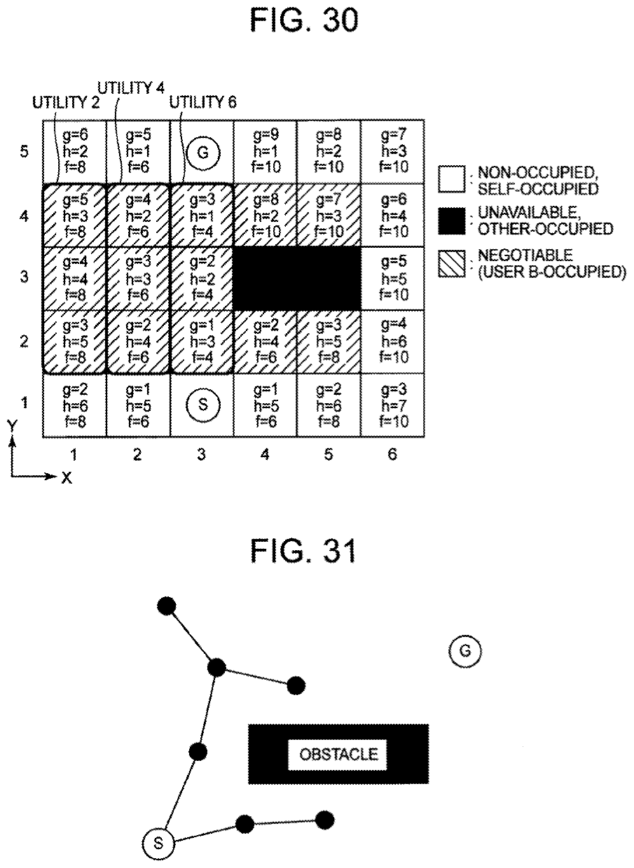

FIG. 30 depicts an explanatory diagram illustrating an example of setting negotiation areas in the example illustrated in FIG. 29. As illustrated in FIG. 30, when a plurality of (p) minimum cost routes are derived, the negotiation area and its utility can be calculated based on each of the routes. In this example, the area on the first minimum cost route in the change area is set as the first negotiation area, and its utility is calculated as 10−4=6. The area on the second minimum cost route in the change area is set as the second negotiation area, and its utility is calculated as 10−6=4. The area on the third minimum cost route in the change area is set as the third negotiation area, and its utility is calculated as 10−8=2.

Thus, when the utilities of the plurality of areas are computed, the plurality of negotiation areas can be presented together with their utilities.

In the above examples, only the four directions to adjacent nodes are described as the moving directions, but the moving directions are not limited thereto. For example, 8-direction movement and 16-direction movement are also possible.

In the above examples, the Manhattan distance is used for h ( ) for computing travel costs, but any cost function may be used. For example, a cost function including elements such as the Euclidean distance, travel distance, and energy consumption may be used.

The maps in the above examples have lattice-like shapes, but the representation of a map is not limited thereto. For example, the above algorithm can be applied to a map having a tree structure.

In the above examples, the A-star algorithm is used for route searches, but another route planning algorithm can also be used. Another example of a route planning algorithm is a rapidly-exploring random tree (RRT) algorithm.

FIG. 31 depicts an explanatory diagram illustrating an example of a node map of the RRT-based optimal route planning algorithm. Here, a circle represents a node. Note that S is the start and G is the goal. Each node corresponds to any one area (management unit area) in the route selection area in free space. A line (edge or branch) connecting nodes represents the route of movement between the nodes. Note that the route length between nodes is Δq.

A route search with the RRT method includes sampling points randomly from free space and adding tree branches. When connecting routes, interference with an obstacle is checked, and a point with no interference is added to the tree. These processes are repeated a predetermined number of sampling times until the goal node is reached, and the solution (route) from the start to the goal can be obtained.

The RRT method enables a route search with relatively high computational efficiency even in high-dimensional state space. However, the optimality of the obtained solution is not guaranteed. Note that there is an extended version of RRT, the RRT* algorithm, which guarantees asymptotic optimality. In the following examples, however, the most basic RRT method is used.

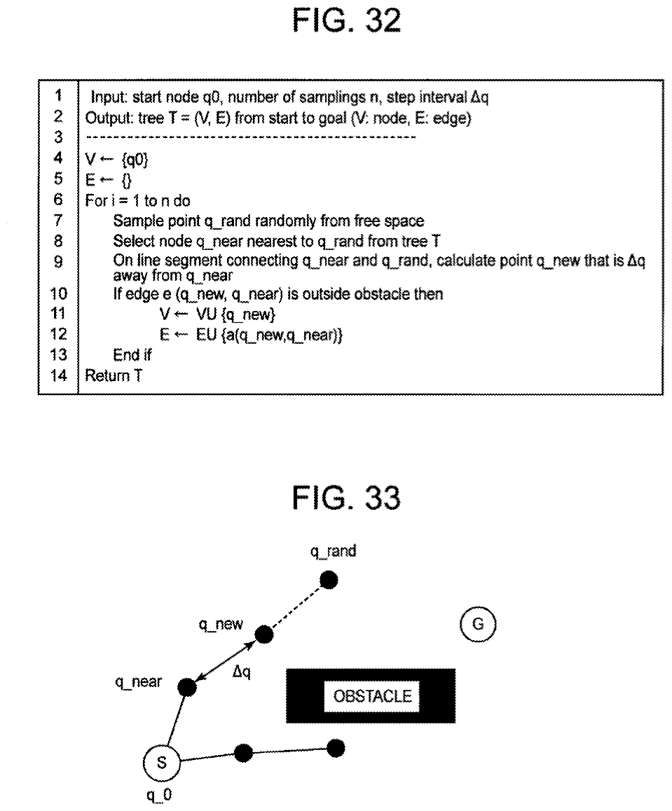

FIG. 32 depicts an explanatory diagram illustrating a pseudocode of the RRT-based optimal route planning algorithm. The optimal route planning algorithm illustrated in FIG. 32 receives input of the start node position q0, the number of samplings n, and the step interval Δq, and outputs the tree T from the start to the goal. Here, the tree T=(V, E) is satisfied. V represents a node set, and E represents an edge set. Note that the processing starts from the fourth line.

In the fourth line, V is {q0}. In the next fifth line, E is an empty set. In the subsequent sixth line, i=1 is set, and the processes in the seventh to twelfth lines are repeated until i reaches the number of samplings n.

In the seventh line, a point q_rand is randomly sampled from free space. In the next eighth line, the node q_near nearest to q_rand is selected from the tree T. In the next ninth line, on the line segment connecting q_near and q_rand, the point q_new that is Δq away from q_near is calculated.

In the next tenth line, it is determined whether the edge e (q_new, q_near) connecting q_new and q_near is outside an obstacle. If so, the processing proceeds to the eleventh line.

In the eleventh line, q_new is added to V. In the next twelfth line, e (q_new, q_near) is added to E.

After the above series of processes (processes in the seventh to twelfth lines) is repeated n sampling times, the tree T is returned, and the processing is ended. FIG. 33 depicts an example of the node map corresponding to this pseudocode.

Next, the area evaluation algorithm of the second example will be described. The area evaluation algorithm of this example calculates the utility of the change area using a route search algorithm obtained by extending the RRT-based optimal route planning for area evaluation.

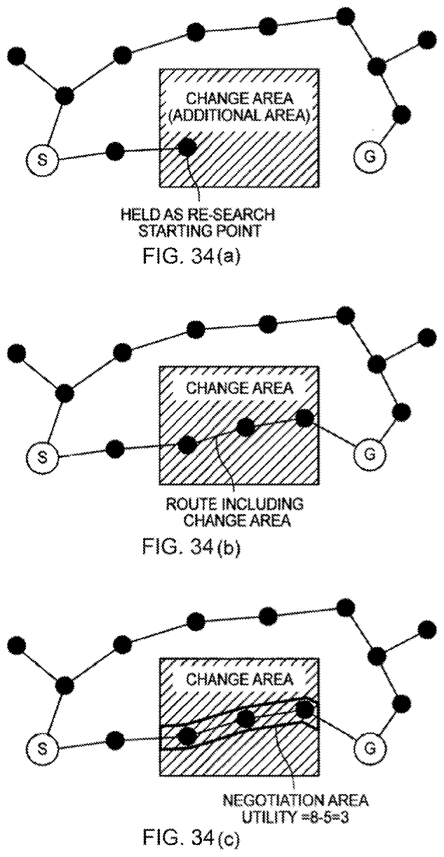

The outline is as follows. In the area evaluation algorithm of the second example, first, the pre-change route selection area is searched using the RRT method, and a route and its cost are calculated (primary route search process). At this time, if the point q_rand or q_new sampled during the search is included in the change area, the point is held as a re-search target (see FIG. 34(a)).

Next, using the held re-search target point as a starting point, the post-change route selection area is re-searched using the RRT method, and the route to the goal is calculated (secondary route search process).

Next, an area having a certain width along the route found in the post-change area is set as a negotiation area (or a change area to be subjected to utility calculation) (see FIGS. 34(b) and 34(c)). Finally, the utility of the area (negotiation area or change area) is calculated using Formula (2). When the cost of the route is calculated as the sum of the inter-node distances between the start and the goal (here, the distance between nodes is constant at one), the utility of the change area in the example of FIG. 34(c) is calculated as 8−5=3. Note that FIG. 34 depicts an explanatory diagram illustrating an example of the processing result of the area evaluation algorithm of the second example.

In the case of area reduction instead of addition, it is only necessary to determine whether the original solution (pre-change expected route) is included in the target area (change area), compute the loss using Formula (3), and calculate the utility, in the manner described in the first example.

The area evaluation algorithm according to the present exemplary embodiment has been described so far with specific examples, but the area evaluation algorithm is not limited thereto. The area search algorithm is also not limited to the A-star method or the RRT method widely used for the route planning algorithm.

As application examples of utility calculation, area changes between two users (one user vs. one user) have been described. However, utility calculation can be applied to area changes between three or more users. For example, one user vs. many users and many users vs. many users are also possible.

In the above-described examples, the utility of an area is proportional to the travel distance. However, the evaluation function is not limited thereto. The evaluation function may vary in accordance with the content, urgency, or the like of the mission of the user who wants to compute utility. For example, when it is necessary to go to the destination urgently, the utility of an area or the underlying travel cost can vary non-linearly according to the travel distance and travel time associated with the route, or if the route cannot lead to the destination by the target time, the utility of the area related to the route can be zero.

In the above examples, the change area is exemplified by the area set by the user as negotiable in the user's occupied area (other-occupied area or self-occupied area), but the change area is not limited thereto. For example, the change area for increase can also be exemplified by a negotiable area of a specific user (e.g. negotiating partner), an occupied area of a specific user, an area other than an unavailable area (in this case, regardless of which user occupies it), and the like.

In a case where occupied areas or negotiable areas of two or more unspecified users are used as the change area for increase, if the acquisition of areas from some of the users who possess the areas on the route fails, the route may become unavailable. In such a case, it is desirable to select a route with as few negotiating users as possible and with a low travel cost. One solution to this is to compute a route by adding the number of users who hold the target area to the constraint condition. In addition, the utility of the additional area can be calculated for each of the case where only the negotiable area of the user A is added and the case where only the negotiable area of the user B is added, and the area of the user with the highest utility can be set as the negotiation area. If negotiations with multiple users are not regarded as a problem (such as in an emergency), a solution can be sought without restriction. Alternatively, the problem to be solved may be separated into that for the number of users=1, that for the number of users=2, that for the number of users=3, and so on, and the utility of the additional area may be computed for each of the problems.

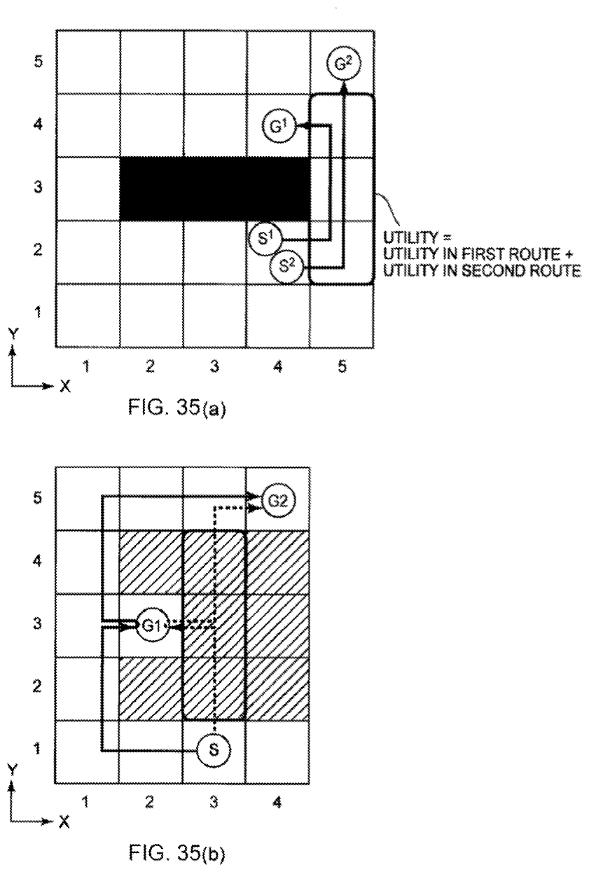

In the above examples, one operation plan (goal-start pair) is set for one user. However, a plurality of operation plans may be set for one user. In that case, an alternative route (route in the post-change area) and its cost are calculated for each of the operation plans, and the utility of the change area is calculated individually. As illustrated in FIG. 35(a), in a case where routes overlap, the final utility of the area on the route may be, for example, the sum of the utilities for the operation plans, the weighted sum of the utilities for the operation plans (effective when the operation plans are assigned different degrees of priority), or the maximum value (increase) or minimum value (reduction) of the utilities for the operation plans.

As described above, the utility of each operation plan only needs to be calculated as follows: the route selection area is virtually increased and/or reduced, the amount of increase or reduction in travel cost associated with the change is determined for a designated partial area (e.g. part or entire change area) related to the operation from the start to the goal in the pre-change and post-change route selection areas, and the utility is calculated based on the amount of increase or reduction in travel cost associated with the change.

In the above examples, one goal is set for one user. However, a plurality of waypoints may be designated. FIG. 35(b) depicts an example of routes for an operation plan in which a plurality of waypoints are set. In this case, it is only necessary to search for a route that sequentially passes through all the waypoints, and calculate its travel cost. For example, the above route search algorithm can be used simply by inputting the waypoints as the first goal, the second goal, and so on.

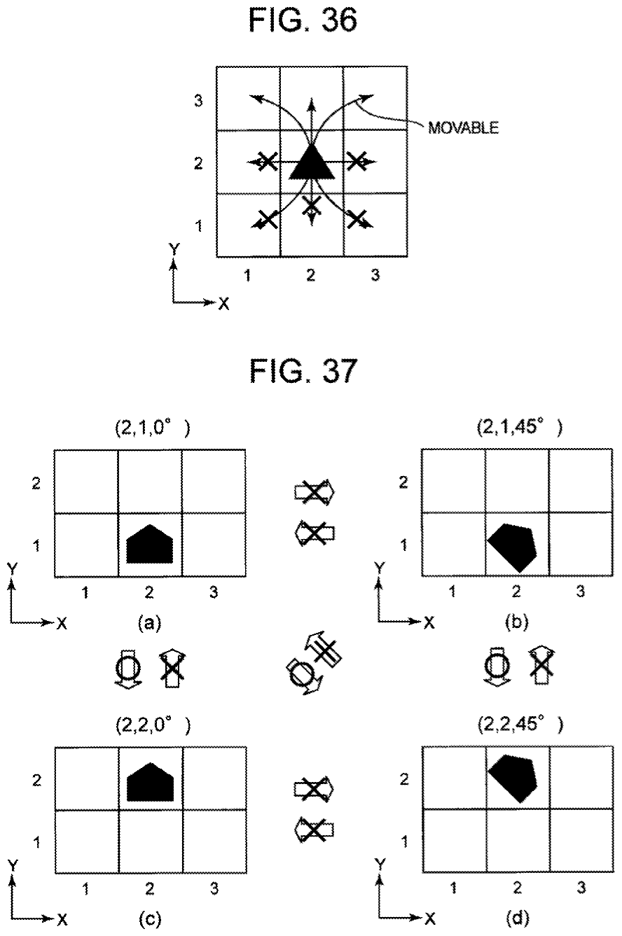

In the above examples, the area search algorithm deals with route planning problems in which only the positions (areas) through which a mobile object passes are considered. However, it is also possible to consider the orientation and attitude of a mobile object at each point on a route. For example, as in the case of a fixed-wing drone, when movable directions are limited according to the orientation of the aircraft, the movable directions only need to be determined according to the orientation at each point as illustrated in FIG. 36.

As an example of a method of searching for a route in consideration of orientation and attitude, a node for the above-mentioned A-star-based search can be expressed by a combination of “position” and “orientation”. In this case, the graph only needs to be defined such that different orientations at the same position have different conditions of “adjacent nodes”. In addition to the A-star, there are many algorithms that can search for a route in consideration of orientation.

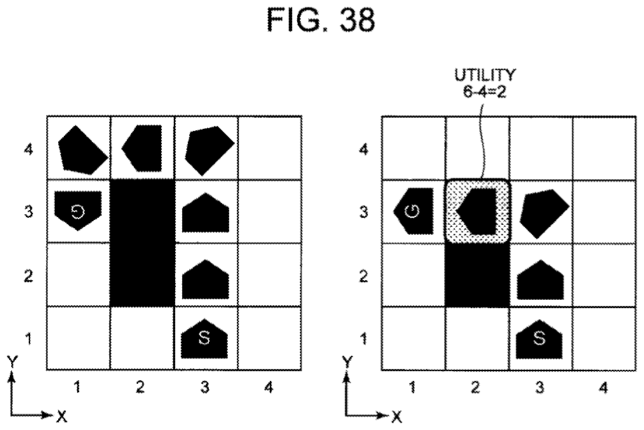

FIG. 37 depicts an explanatory diagram illustrating an example of movable directions according to the position and orientation of a mobile object. In FIG. 37, each node is represented by (x, y, θ). Here, θ is the orientation of the mobile object. In this example, the mobile object is only permitted to move forward in the same orientation or move forward while rotating 45°. Note that the mobile object cannot change its orientation while staying in the same position (cannot turn on the spot). Note that these conditions may vary depending on the form of the mobile object and the size of the area.

In a case where the area is changed as illustrated in FIG. 38, since different orientations at the same position have different conditions of adjacent nodes, a route search is conducted in consideration of orientation. In the example illustrated in FIG. 38, the travel cost for passing only through the non-occupied area is 6, whereas the travel cost for the case that an other-occupied area is added is 4. Therefore, the utility of the area on the post-change route in the change area is calculated as 2. Note that the above-described formulas can be used for calculating travel costs and area utilities.

Further, a problem can be solved not as what is called a “route plan” but as a “trajectory plan” for deriving those that include additional information such as the transit time, speed, and acceleration at each transit position.

The above examples consider searches within a certain time frame in which the area assignment does not change, but the area assignment status changes with time. When the change time is short with respect to the travel distance, an area search, a route search, or a trajectory search can be performed by adding a time-directional axis to the dimensions to be searched.

For example, in the robot field, a set of positions through which a mobile object passes and the mobile object's attitudes may be referred to as a “route”. For the route in this sense, the transit time and transit speed at each point are not considered. In contrast, a route with the transit time and transit speed designated at each point is called a “trajectory”. A trajectory plan calculates even the transit time at each position so as to explicitly guarantee the arrival time. Moreover, it further calculates the transit speed at each position so as to explicitly guarantee that the mobile object can surely pass through each position at that speed. In other words, a feasible plan can be made in consideration of limitations such as the speed and acceleration of the mobile object.

An example of a trajectory planning method is described in the document “C. Richer, et. al, ‘Polynomial trajectory planning for aggressive quadrotor flight in dense indoor environments’, ISRR 2013”. Note that this method includes calculating points (x, y, z, orientation) on the route from the start to the goal using the RRT* algorithm, regarding the trajectory connecting these points as a time-related polynomial, and performing numerical optimization under limiting conditions of speed and acceleration to obtain a solution.

Note that the following method can be used as an exemplary method of utility calculation for a trajectory plan. First, the travel cost is calculated for the optimal trajectory (position+time) obtained using the pre-change area. Next, the optimal trajectory is calculated using the post-change area, and its travel cost is calculated. Then, in the change area, a certain width is added to the post-change trajectory to form an area, and the utility of this area is calculated using Formula (2) and Formula (3) in the above-mentioned manner. In this case, the target area and its utility can change with time.

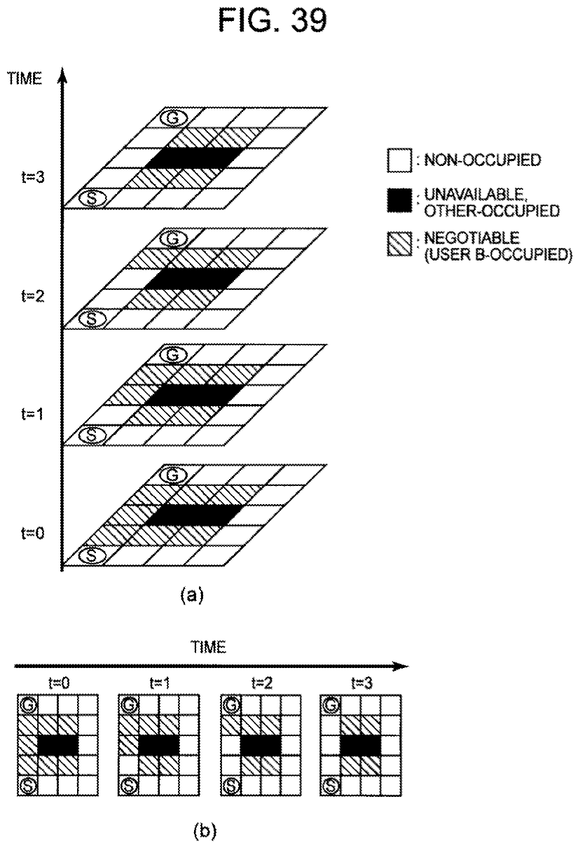

FIG. 39 depicts an explanatory diagram illustrating a time extension graph as an example of a graph for a search in which the time axis is considered. As illustrated in FIG. 39, each user releases unnecessary occupied areas with time, for example. The released occupied areas become non-occupied areas. By searching for a route using such a time extension graph, a search in which the time axis is considered can be performed.

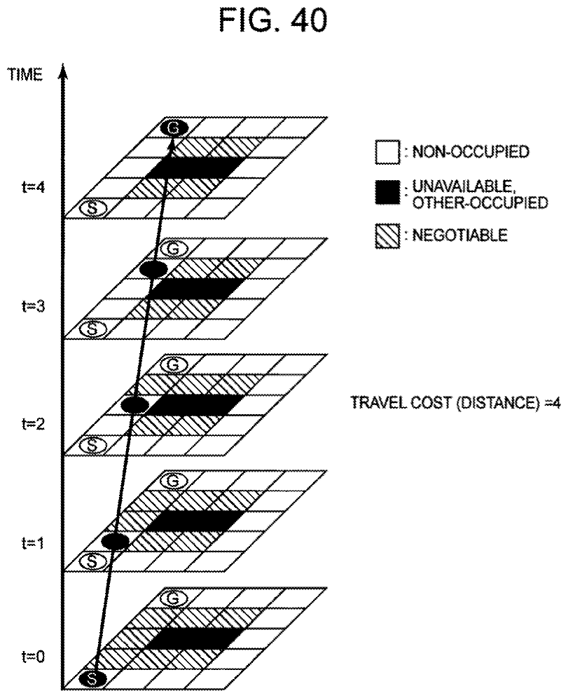

FIGS. 40 to 43 depict explanatory diagrams illustrating an example of route search and utility calculation with a time extension graph. First, as illustrated in FIG. 40, an optimal trajectory (position+time) is sought using the pre-change area extending also in the time axis direction, and its travel cost is calculated. In this example, travel cost=distance is satisfied. Note that the travel cost of the optimal trajectory in the pre-change area is calculated as 4.

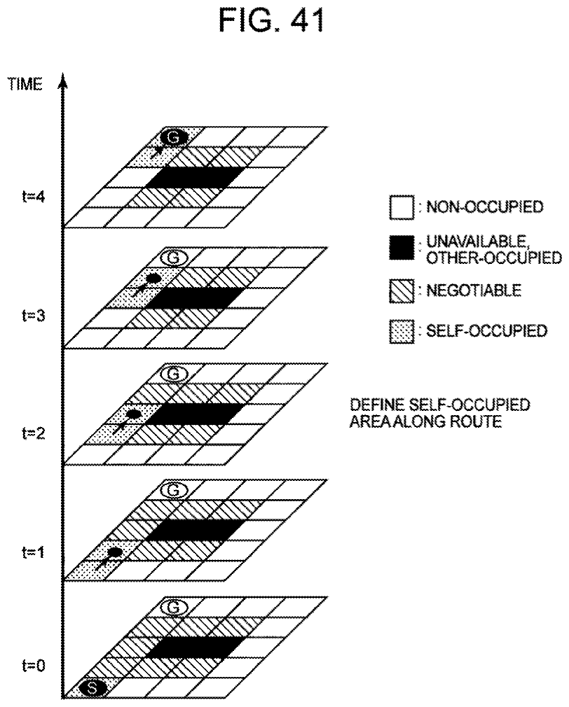

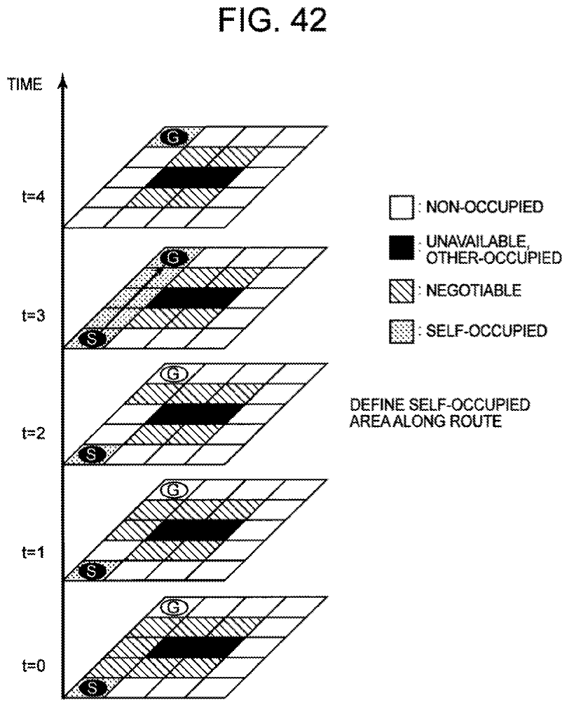

Next, as illustrated in FIG. 41, a self-occupied area is defined along the route (trajectory). Note that, as illustrated in FIG. 42, a plurality of ways of taking a trajectory are conceivable depending on the target arrival time, the speed of the mobile object, and the like. In the example illustrated in FIG. 42, the mobile object waits at the start point until time t2, and moves from the start to the goal at time t3. FIG. 42 depicts an example of such a trajectory and an example of the self-occupied area set based on the trajectory. At time t4, the occupied areas that are no longer be used are released as non-occupied areas.

In this way, the optimal trajectory and its travel cost for the case that the other-occupied area is acquired and the optimal trajectory and its travel cost for the case that the other-occupied area is not acquired are obtained. Note that the utility calculation itself may be the same as when the time-directional search is not performed. However, it should be noted that the cost to be compared differs depending on the time frame for which the utility is calculated.

For example, in the example illustrated in FIG. 40, when a search is conducted only at time t0, the route that uses only the non-occupied area is a detour, and its travel cost is 10 (see FIG. 21(a)). In this state, when the post-change route including the other-occupied area is computed only at time t0, the optimal route is set, and its travel cost is 4 (see FIG. 21(b)). In this case, without considering the time axis direction, the utility of the additional area is calculated as 10−4=6.

On the other hand, when a search is conducted in consideration of the time axis direction, the mobile object can move to the goal using only the non-occupied area as illustrated in FIG. 42. Suppose that the mobile object only needs to reach the goal by time t4, and only the distance is considered in relation to utility. In this case, the utility of acquiring the other-occupied area at time t0 can be calculated as 4−4=0.

Alternatively, for example, suppose that the mobile object needs to reach the goal by time t1 and wants to use as short a route as possible, the utility (10−4=6) occurs in acquiring the other-occupied area at time t0. Thus, the utility of an area varies depending on the time frame associated with a negotiation for area addition with another entity or a negotiation offered by another entity.

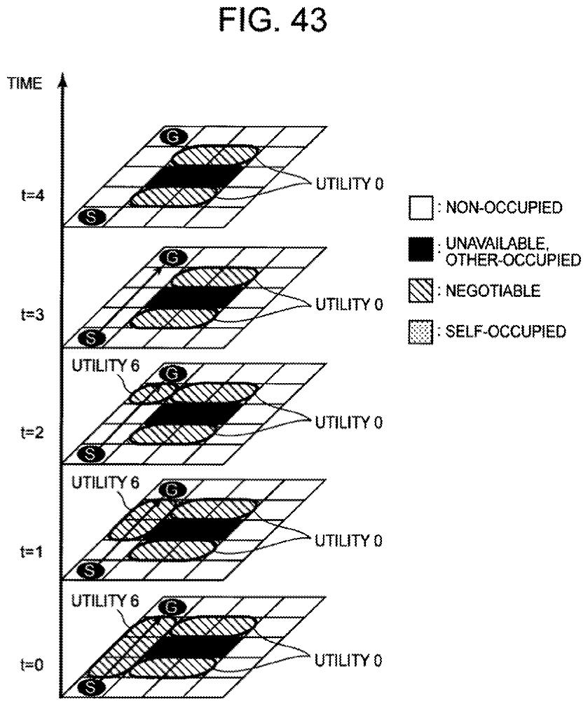

For example, as illustrated in FIG. 43, when time t0 is set as the time frame associated with a negotiation for change, utility=6 occurs for the three areas, a1_2, a1_3, and a1_4. In addition, for example, when time t1 is set as the time frame associated with a negotiation for change, utility=6 occurs for the two areas a1_3 and a1_4. In addition, for example, when time t2 is set as the time frame associated with a negotiation for change, utility=6 occurs for the one area a1_4. In addition, for example, when time t3 is set as the time frame associated with a negotiation for change, the pre-change area (non-occupied area) is sufficient to cover the optimal route, so there is no additional area where some utility can be obtained.

As described above, according to the present exemplary embodiment, the utility of an area used for operation can be appropriately evaluated in accordance with a designated operation plan.

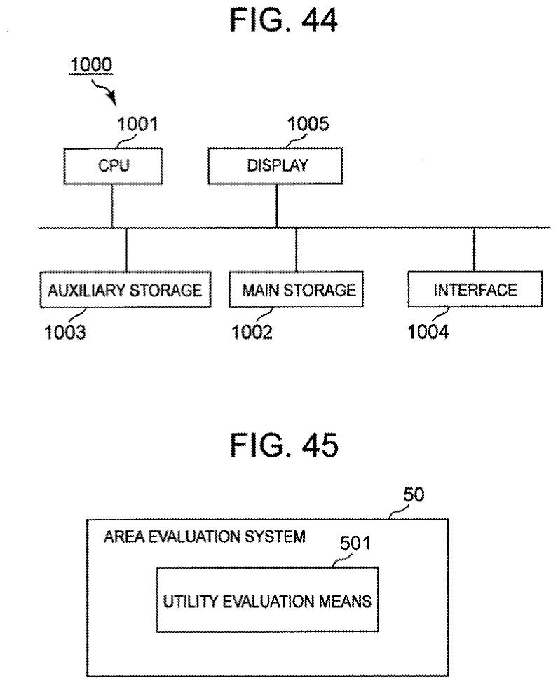

Next, a configuration example of a computer according to an exemplary embodiment of the present invention will be described. FIG. 44 depicts a schematic block diagram illustrating a configuration example of a computer according to an exemplary embodiment of the present invention. The computer 1000 includes a CPU 1001, a main storage 1002, an auxiliary storage 1003, an interface 1004, a display 1005, and an input device 1006.

The operation management system described above may be implemented in the computer 1000, for example. In that case, the operation of each component may be stored in the auxiliary storage 1003 in the form of a program. The CPU 1001 reads the program from the auxiliary storage 1003, develops it in the main storage 1002, and executes the predetermined processing in the above exemplary embodiment according to the program.

The auxiliary storage 1003 is an example of a non-temporary tangible medium. Other examples of non-temporary tangible media include a magnetic disk, a magneto-optical disk, a CD-ROM, a DVD-ROM, and a semiconductor memory connected via the interface 1004. In a case where this program is distributed to the computer 1000 via a communication line, the computer 1000 that has received the distribution may develop the program in the main storage 1002 and execute the predetermined processing in the above exemplary embodiment.

The program may implement part of the predetermined processing in each exemplary embodiment. Furthermore, the program may be a differential program that implements the predetermined processing in the above exemplary embodiment in combination with another program already stored in the auxiliary storage 1003.

The interface 1004 transmits/receives information to/from other devices. The display 1005 presents information to the user. The input device 1006 accepts input of information from the user.

Depending on the processing content in the exemplary embodiment, some elements of the computer 1000 may be omitted. For example, the input device 1006 can be omitted if input of information is not directly accepted from the user, and the display 1005 can be omitted if information is not directly presented to the user.

Some or all of the components of the system are implemented by general-purpose or dedicated circuits (circuitry), processors, or combinations thereof. These may be formed by a single chip or may be formed by a plurality of chips connected via a bus. Some or all of the components of the system may be implemented by a combination of circuits and programs mentioned above.

When some or all of the components are implemented by a plurality of information processing devices, circuits, and the like, the plurality of information processing devices, circuits, and the like may be centralized or distributed. For example, the information processing devices, circuits, and the like may be implemented as a client server system, a cloud computing system, or the like in which the information processing devices, circuits, and the like are connected via a communication network.

Next, the area management system of the present invention will be schematically described. FIG. 45 depicts a block diagram schematically illustrating the area management system of the present invention. The area evaluation system 50 illustrated in FIG. 45 includes a utility evaluation means 501.

The utility evaluation means 501 (for example, the area evaluation means 30 or the utility calculation unit 303) evaluates, in a case where a route selection area in which a route is selected is changed, a utility of at least a partial area included in a pre-change or post-change route selection area based on operation routes for an operation plan of a mobile object in pre-change and post-change areas.

For example, the utility evaluation means 501 virtually increases and/or reduces the route selection area, obtains operation routes for the operation plan of the mobile object in the pre-change and post-change route selection areas, determines an amount of increase or reduction in travel cost associated with the change, and evaluates the utility of at least the partial area included in the pre-change or post-change route selection area based on the amount of increase or reduction in travel cost associated with the change.

According to the above configuration, the utility of an area used for operation can be appropriately evaluated in accordance with a designated operation plan.

Note that the above exemplary embodiment can also be described as in the following supplementary notes.

### (Supplementary Note 1)

An area evaluation system including

a utility evaluation means that, in a case where a route selection area in which a route is selected is changed, evaluates a utility of at least a partial area included in a pre-change or post-change route selection area based on operation routes for an operation plan of a mobile object in pre-change and post-change areas.

### (Supplementary Note 2)

The area evaluation system according to supplementary note 1, wherein the utility evaluation means virtually increases and/or reduces the route selection area, obtains operation routes for the operation plan in the pre-change and post-change route selection areas, determines an amount of increase or reduction in travel cost associated with the change, and evaluates the utility of at least the partial area based on the amount of increase or reduction in travel cost associated with the change.

### (Supplementary Note 3)

The area evaluation system according to supplementary note 1 or 2, wherein the utility evaluation means virtually increases the route selection area, searches for an operation route for the operation plan using the post-change route selection area, and in response to finding an operation route with a lower travel cost than a pre-change optimal route, evaluates a utility of an area on the operation route included in an increase target area based on an amount of reduction in travel cost associated with the change.

### (Supplementary Note 4)

The area evaluation system according to supplementary note 3, wherein

the utility evaluation means searches for the operation route using a post-increase route selection area, and in response to finding an operation route with a lower travel cost than a pre-increase optimal route, evaluates, as zero, a utility of an area other than the area on the operation route included in the increase target area.

### (Supplementary Note 5)

The area evaluation system according to any one of supplementary notes 1 to 4, wherein in a case where the utility evaluation means calculates a utility associated with a reduction in the route selection area, when an area on an optimal route for the operation plan in a pre-reduction area is included in a reduction target area, the utility evaluation means evaluates a utility of the area on the optimal route included in the reduction target area based on an amount of increase in travel cost associated with the change.

### (Supplementary Note 6)

The area evaluation system according to any one of supplementary notes 1 to 5, wherein in a case where an area on a pre-change optimal route is included in the reduction target area, the utility evaluation means excludes the area on the optimal route included in the reduction target area from a reduction target.

### (Supplementary Note 7)

The area evaluation system according to any one of supplementary notes 1 to 6, wherein the utility evaluation means includes: a first cost deriving means that derives an operation route for the operation plan and its travel cost using the pre-change route selection area; a second cost deriving means that derives an operation route for the operation plan and its travel cost using the post-change route selection area; and a utility calculation means that calculates the utility of at least the partial area included in the pre-change or post-change route selection area based on the operation route and its travel cost derived using the pre-change route selection area and the operation route and its travel cost derived using the post-change route selection area.

### (Supplementary Note 8)

The area evaluation system according to supplementary note 7, wherein the utility calculation means calculates a utility of a change target area or an area on a pre-change or post-change route included in the change target area.

### (Supplementary Note 9)

The area evaluation system according to supplementary note 7 or 8, wherein the second cost deriving means derives the operation route in the post-change route selection area and its travel cost using information on the travel cost or a travel destination obtained when the first cost deriving means derives the operation route and its travel cost.

### (Supplementary Note 10)

The area evaluation system according to any one of supplementary notes 7 to 9, wherein the second cost deriving means searches for a predetermined number of operation routes with a travel cost lower than a travel cost of an optimal route derived by the first cost deriving means, and outputs a result, and the utility calculation means calculates the utility of at least the partial area included in the pre-change or post-change route selection area based on an amount of increase or reduction, relative to the optimal route derived using the pre-change route selection area, in the travel cost of each of the operation routes found by the second cost deriving means.

### (Supplementary Note 11)

The area evaluation system according to any one of supplementary notes 7 to 10, wherein a search for an operation route is performed in a time axis direction.

### (Supplementary Note 12)

The area evaluation system according to any one of supplementary notes 7 to 11, wherein information on orientation, attitude, speed, or acceleration is used for a search for an operation route.

### (Supplementary Note 13)

The area evaluation system according to any one of supplementary notes 1 to 12, wherein an area to be added includes an occupied area occupied by another user.

### (Supplementary Note 14)

The area evaluation system according to any one of supplementary notes 1 to 13, wherein an area to be reduced includes an occupied area occupied by the area evaluation system itself

### (Supplementary Note 15)

An area evaluation method including evaluating, by an information processing device, in a case where a route selection area in which a route is selected is changed, a utility of at least a partial area included in a pre-change or post-change route selection area based on operation routes for an operation plan of a mobile object in pre-change and post-change areas.

### (Supplementary Note 16)

An area evaluation program for causing a computer to execute a process of, in a case where a route selection area in which a route is selected is changed, evaluating a utility of at least a partial area included in a pre-change or post-change route selection area based on operation routes for an operation plan of a mobile object in pre-change and post-change areas.

Although the present invention has been described with reference to the exemplary embodiment and examples, the present invention is not limited to the above-described exemplary embodiment and examples. Various changes that can be understood by those skilled in the art can be made to the configurations and details of the present invention within the scope of the present invention.

For example, in the above-described exemplary embodiment and specific examples, utility is calculated for area applications or area negotiations in a distributed operation management system. However, the application of utility is not limited thereto. For example, utility can also be used in all situations where the area in which a route is selected is changed due to an action such as application or permission, for the purpose of determining whether the change is allowed.

This application claims priority based on Japanese Patent Application No. 2017-128392 filed on Jun. 30, 2017, the disclosure of which is incorporated herein in its entirety.

### INDUSTRIAL APPLICABILITY

The present invention can be advantageously applied not only to area negotiations in a distributed operation management system but also to situations where the area in which a route is selected is changed due to an action such as application or permission, for the purpose of determining whether the change is allowed.

### REFERENCE SIGNS LIST

100 Mobile operation system
10 Area management system
20 Operation management system
30 Area evaluation means
301 Pre-change cost calculation unit
302 Post-change cost calculation unit
303 Utility calculation unit
50 Area evaluation system
501 Utility evaluation means
1000 Computer
1001 CPU
1002 Main storage
1003 Auxiliary storage
1004 Interface
1005 Display
1006 Input device

1. An area evaluation system comprising
a utility evaluation unit that, in a case where a route selection area in which a route is selected is changed, evaluates a utility of at least a partial area included in a pre-change or post-change route selection area based on operation routes for an operation plan of a mobile object in pre-change and post-change areas.

2. The area evaluation system according to claim 1, wherein
the utility evaluation unit virtually increases and/or reduces the route selection area, obtains operation routes for the operation plan in the pre-change and post-change route selection areas, determines an amount of increase or reduction in travel cost associated with the change, and evaluates the utility of at least the partial area based on the amount of increase or reduction in travel cost associated with the change.

3. The area evaluation system according to claim 1, wherein
the utility evaluation unit virtually increases the route selection area, searches for an operation route for the operation plan using the post-change route selection area, and in response to finding an operation route with a lower travel cost than a pre-change optimal route, evaluates a utility of an area on the operation route included in an increase target area based on an amount of reduction in travel cost associated with the change.

4. The area evaluation system according to claim 3, wherein
the utility evaluation unit searches for the operation route using a post-increase route selection area, and in response to finding an operation route with a lower travel cost than a pre-increase optimal route, evaluates, as zero, a utility of an area other than the area on the operation route included in the increase target area.

5. The area evaluation system according to claim 1, wherein
in a case where the utility evaluation unit calculates a utility associated with a reduction in the route selection area, when an area on an optimal route for the operation plan in a pre-reduction area is included in a reduction target area, the utility evaluation unit evaluates a utility of the area on the optimal route included in the reduction target area based on an amount of increase in travel cost associated with the change.

6. The area evaluation system according to claim 5, wherein
in a case where an area on a pre-change optimal route is included in the reduction target area, the utility evaluation unit excludes the area on the optimal route included in the reduction target area from a reduction target.

7. The area evaluation system according to claim 1, wherein
the utility evaluation unit includes:
a first cost deriving unit that derives an operation route for the operation plan and its travel cost using the pre-change route selection area;
a second cost deriving unit that derives an operation route for the operation plan and its travel cost using the post-change route selection area; and
a utility calculation unit that calculates the utility of at least the partial area included in the pre-change or post-change route selection area based on the operation route and its travel cost derived using the pre-change route selection area and the operation route and its travel cost derived using the post-change route selection area.

8. The area evaluation system according to claim 7, wherein
the utility calculation unit calculates a utility of a change target area or an area on a pre-change or post-change route included in the change target area.

9. The area evaluation system according to claim 7, wherein
the second cost deriving unit derives the operation route in the post-change route selection area and its travel cost using information on the travel cost or a travel destination obtained when the first cost deriving unit derives the operation route and its travel cost.

10. The area evaluation system according to claim 7, wherein
the second cost deriving unit searches for a predetermined number of operation routes with a travel cost lower than a travel cost of an optimal route derived by the first cost deriving unit, and outputs a result, and
the utility calculation unit calculates the utility of at least the partial area included in the pre-change or post-change route selection area based on an amount of increase or reduction, relative to the optimal route derived using the pre-change route selection area, in the travel cost of each of the operation routes found by the second cost deriving unit.

11. The area evaluation system according to claim 7, wherein
a search for an operation route is performed in a time axis direction.

12. The area evaluation system according to claim 7, wherein
information on orientation, attitude, speed, or acceleration is used for a search for an operation route.

13. The area evaluation system according to claim 1, wherein
an area to be added includes an occupied area occupied by another user.

14. The area evaluation system according to claim 1, wherein
an area to be reduced includes an occupied area occupied by the area evaluation system itself.

15. An area evaluation method comprising
evaluating, by an information processing device, in a case where a route selection area in which a route is selected is changed, a utility of at least a partial area included in a pre-change or post-change route selection area based on operation routes for an operation plan of a mobile object in pre-change and post-change areas.

16. A non-transitory computer-readable recording medium in which an area evaluation program is recorded, the area evaluation program causing a computer to execute
a process of, in a case where a route selection area in which a route is selected is changed, evaluating a utility of at least a partial area included in a pre-change or post-change route selection area based on operation routes for an operation plan of a mobile object in pre-change and post-change areas.
